(19) United States
(12) Patent Application Publication
(10) Pub. No.: US 2007/0039881 A1
(43) Pub. Date: Feb. 22, 2007

(54) Method and apparatus for solution/separation at predetermined temperature with solvent set undergoing temperature-dependent reversible change between solution phase and separation phase

(76) Inventor: Kazuhiro Chiba, Tokyo (JP)

Correspondence Address: HAMMER & HANF, PC, 3125 SPRINGBANK LANE, SUITE G, CHARLOTTE, NC, 28226, US

(21) Appl. No.: 10/554,951

(22) PCT Filed: Apr. 27, 2004
(86) PCT No.: PCT/JP04/06064

§ 371 Date: Jul. 19, 2006

(30) Foreign Application Priority Data
May 1, 2003 (JP) 2003-126595

(51) Int. Cl. B01D 11/04

(52) U.S. Cl. 210/634; 212/101; 585/833; 585/834; 210/511

(57) ABSTRACT

A method for solution/separation phase change at a constant temperature (with no temperature change) in a combination of a first solvent and a second solvent of a mixture of plural solvents that undergoes temperature-dependent reversible change between solution phase and separation phase. A method for solubilization or phase separation of first and second solvents at a constant temperature by adding thereto a solvent that constitutes the first solvent and/or the second solvent, on the basis of the solution/separation temperature data relative to the blend ratio of the first and second solvents and the composition blend ratio of the second solvent in the solvent set that is in a separation phase, in such a manner that the first and second solvents may have a blend ratio at which they may undergo solution/separation phase change at a temperature lower than the temperature of the separation-phase solvent set.

### TECHNICAL FIELD

The present invention provides a solvent system capable of facilitating chemical reaction control and facilitating chemical product recovery and a method of using it, suggesting a method for producing a compound by the use of the solvent system, and provides an apparatus with it.

The solvent system is a combination of a first solvent having a relatively low permittivity or polarity and a second solvent having a relatively high permittivity or polarity, in which the first solvent and the second solvent each may be a mixed solvent of plural solvents. Needless-to-say, they each may be a single solvent. The combination of a first solvent and a second solvent is herein referred to as “solvent combination”, or “solvent system”, or “solvent set”. In this description, however, these “solvent combination”, “solvent system” and “solvent set” all have the same meaning. The “solvent” is a liquid medium that dissolves “a solute” to give “a solution”, in which chemical reaction goes on. The “chemical reaction” to which the invention applies shall be taken in the broad sense of the word. Specifically, it has a broad meaning, including internal reaction in organisms (bioreaction) and physical reaction by light or radiations with no distinction between them. Forcedly defined, it includes all substance change processes that are interpreted as an exchange of basic substance constitutive elements such as electrons.

Importantly, the invention provides a novel technique relating to a site of “chemical reaction” of a “solvent”. However, the substance of this technique is the “solution” prepared by dissolving a reactive substance, “a solute” in the “solvent”. Not including the explanation of embodiments of the substance as omitted herein, this description is to explain the site of “chemical reaction” of a “solvent”, or that is, the solvent system and the method of using it. This is because the utilization of “solute” of all reaction substances such as chemical substances and biological substances in the chemical reaction site includes multifarious conditions thereof and it is difficult to comprehensively explain it, and even in the absence of individual explanation thereof, the applicability of the invention is readily understood. One that desires concrete examples shall refer to Patent Reference 1 or Patent Reference 2 which describes applications to peptide synthesis as further embodiments of Patent Reference 1.

### BACKGROUND ART

We, the present inventors have proposed a novel solvent set that enable easy control of temperature-dependent phase change between solution phase and separation phase and is applicable to a broad range of chemical processes such as reaction control and product separation/purification owing to the phase change control, and therefore brings about a large variety of industrial advantages to the processes (see Patent Reference 1). Repeatedly speaking, the solvent set is applicable to all processes that are interpreted as an exchange of basic substance constitutive elements such as electrons, as taken in the broad sense of the word with no distinction between internal reaction in organisms and physical reaction.

Needless-to-say, the processes include intramolecular and intermolecular reaction, intramolecular and intermolecular interaction, electron transfer, separation based on the mobility speed difference between substances, extraction separation and solvent fractionation based on the difference in partition coefficient. A plain example of a chemical process using the solvent set is liquid-phase peptide synthesis described in Patent Reference 2 mentioned above (see Patent Reference 2, Non-Patent Reference 1).

An example of the first solvent that constitutes the solvent set is cyclohexane, and an example of the second solvent that constitutes the solvent set is DMI (dimethylimidazolidinone), and other various substances maybe used to constitute the solvent set. Wide-ranging candidate substances are shown in Patent Reference 1 and Patent Reference 3. As will be a repetition thereof given in Patent Reference 1 and Patent Reference 3, explanation of the candidate substances is omitted herein.

A point of the conventional solvent set proposed by the present inventors is that it enables easy control of temperature-dependent phase change between solution phase and separation phase. In this description, the temperature at which a separation phase at a relatively low temperature changes to a solution phase at a relatively high temperature is defined as “solution/separation critical temperature”. Needless-to-say, when a phase is cooled down from a relatively high temperature to a temperature lower than the solution/separation critical temperature contrary to the above, then it changes to a separation phase. The solution/separation critical temperature is experimentally determined. More strictly, the solution/separation critical temperature may cover a statistical/thermodynamic (quantum-mechanical) range, which, however, will not be taken into consideration in this description, and the temperature shall be a non-varying point numerical value. There is no substantial problem since the reproducibility is statistically ensured.

<Solution/Separation Critical Temperature>

Patent Reference 1 describes that, when the constitution of the first solvent or the second solvent is changed, then it may be possible to freely change the temperature for phase change between solution phase and separation phase (solution/separation critical temperature). FIG. 1 and FIG. 2, which are the same as those in Patent Reference 1, concretely show it. FIG. 1 illustrates a graph of experimental data relating to the constitution of a first solvent, cyclohexane (CH) and a second solvent, mixed solvent of nitroalkanes (NA) and the change of solution phase temperature. In this, the volume ratio of CH to NA is 1:5, 2:5, 1:1 and 5:1 as parameters, and the blend ratio by volume of nitromethane (NM) and nitroethane (NE) constituting the respective NA is on the horizontal axis and the solvent temperature is on the vertical axis, and the solution/separation critical temperature data in mixing the two solvents are plotted in the graph.

In FIG. 2, a first solvent, cyclohexane (CH) and a second solvent are fixed in a ratio of 1/1 by volume (each 50 vol. %), and the second solvent is a mixed solvent of nitromethane (NM) and nitroethane (NE), or a mixed solvent of acetonitrile (AN) and propionitrile (PN), or a mixed solvent of dimethylformamide (DMF) and dimethylacetamide (DMA). In this, the blend ratio by volume of the second solvent is on the horizontal axis and the solvent temperature is on the vertical axis, and the solution/separation critical temperature data in mixing the two solvents are plotted in the graph.

From FIG. 1 and FIG. 2, it is understood that the solution/separation critical temperature varies within a range of from 20° C. to 60° C., depending on the constitution of the first and second solvents. In other words, in a set of a first solvent and a second solvent, when a method of changing the constitution of the first and second solvents is available, then the solution/separation critical temperature of the two solvents can be changed. This indicates the possibility of solution-phase chemical reaction at a relatively low temperature level.

<Polarity or Permittivity>

Technical standards relating to polarity or permittivity are described in Non-Patent Reference 2 and Non-Patent Reference 3. Specifically, the experimental evaluation of polarity (ET (30)) may be attained according to the method described in Non-Patent Reference 3; and the experimental evaluation of permittivity may be attained according to the method described in Non-Patent Reference 2. When the condition of a low-polarity solvent that is referred to as a first solvent in Patent Reference 3 is described according to these, then its permittivity is from 0 to 15 and its polarity (ET30) is less than 20. Similarly, when the condition of a high-polarity solvent referred to as a second solvent therein is described according to these, its polarity (ET (30)) is at least 25 and its permittivity is at least 20.

The solvent system of the present invention is a combination of a first solvent having a relatively low permittivity or polarity, and a second solvent having a relatively high permittivity or polarity. Accordingly, the polarity or permittivity could be physical data to be a key of the solution/separation phenomenon in the invention. Since temperature change may bring about polarity or permittivity change, it is believed that the change may cause a solution/separation phenomenon.

The references are mentioned below.

JP-A-2003-62448 “COMPATIBLE-MULTIPHASE ORGANIC SOLVENT SYSTEM” (Patent Reference 1),

JP-A-2003-18298 “METHOD OF LIQUID-PHASE PEPTIDE SYNTHESIS THROUGH SUCCESSIVE ADDITION OF AMINO ACID WITH COMPATIBLE-MULTIPHASE ORGANIC SOLVENT SYSTEM” (Patent Reference 2),

Japanese Patent Application No. 2003-45815 “METHOD OF CHEMICAL PROCESS USING SOLVENT COMBINATION FOR TEMPERATURE-DEPENDENT REVERSIBLE CHANGE OF SOLUTION/SEPARATION PHASE” (Patent Reference 3),

“A liquid-phase peptide synthesis in cyclohexane-based biphasic thermomorphic systems”, Kazuhiro Chiba, Yusuke Kono, Shokaku Kim, Kohsuke Nishimoto, Yoshikazu Kitano and Masahiro Tada, Chem. Commun., 2002, (Advance Article), The Royal Society of Chemistry, 1766-1767, 2002, (first published on the web 15th July 2002) (Non-Patent Reference 1),

J. A. Riddick and W. B. Bunder (eds.), Organic Solvents, Vol. II of Techniques of Organic Chemistry, Third Edition, Wiley-Interscience, New York, 1970,

C. Reichardt and K. Dimroth, Fortshr. Chem. Forsch., 11, 1 (1968),

C. Reichardt, Justus Liebigs, Ann. Chem., 725, 64 (1971) (Non-Patent Reference 2).

A problem that the invention is to solve is how to readily and temperature-independently control the phase change between solution phase and separation phase in a conventional solvent set. In mass production of a compound, naturally the thermal capacity of the reactor to be used shall be large, therefore requiring much energy for its temperature change. On the other hand, another method may be employable, in which a high-temperature chamber and a low-temperature chamber each having a predetermined temperature are prepared, and solvent sets and reactants are moved between them during the reaction process. However, this is unfavorable since some units for their movement must be combined into the method and they may increase the production costs.

Concretely, the problem that the invention is to solve is how to readily control the phase change between solution phase and separation phase at a constant temperature. Solving the problem is nothing else but attaining the essential matter of solution/separation change in a solvent set. In other words, from the viewpoint that temperature change is only one condition of inducing the solution/separation phenomenon, we the present inventors have investigated the essential condition including it.

### DISCLOSURE OF THE INVENTION

The present invention presents a basic concept including conventional, temperature-dependent solution/separation phase change. Specifically, the solution/separation change in the solvent set of the invention has started from an investigation of a generic-conceptual scientific ground including temperature, and this is described below.

As described hereinabove, the solvent system is a combination of a first solvent having a relatively low permittivity or polarity and a second solvent having a relatively high permittivity or polarity. Concretely with reference to the physical data defined in Non-Patent Reference 2 and Non-Patent Reference 3, the permittivity of the first solvent is from 0 to 15 or the polarity (ET30) of the first solvent is less than 20, and the permittivity of the second solvent is at least 20 or the polarity (ET30) of the second solvent is at least 25. Solution/separation may occur owing to the change of the permittivity or the polarity.

(First Aspect of the Invention)

Accordingly, the permittivity or polarity change shall be induced even in the absence of temperature change. Therefore, a change-inducer substance may be added. This may be realized by solvents that constitute a solvent set. The first aspect of the invention is that, when the first solvent or at least one elemental solvent of plural solvents constituting the second solvent that is in a separation phase from the first solvent is added so that the added amount thereof is to reduce the permittivity difference or the polarity difference between the first solvent and the second solvent that are in a separation phase, relatively by at least 10%, then the two solvents may be solubilized. In other words, a separation phase may be solubilized by adding a substance that constitutes the solvent set to the solution.

The substance to be added may be any “third” substance except those constituting the solvent set. For example, the additive substance may be a solute of the first and second solvents. In other words, when a solute substance capable of dissolving in the first solvent in a separation phase or a solute substance capable of dissolving in the second solvent is added to the solvent set and when the added amount thereof is to reduce the permittivity difference between the first solvent and the second solvent that are in a separation phase or to reduce the polarity difference between the first solvent and the second solvent that are in a separation phase, relatively by at least 10%, then the two solvents may be solubilized.

(Second Aspect of the Invention) For separating the solution phase, the added amount shall be, contrary to the above, to increase the permittivity difference or the polarity difference relatively by at least 10%. As being simple substitution or repetition, this explanation is herein omitted.

At present, it is difficult to attain real-time detection (real-time monitoring) of the relative change of the permittivity difference or the polarity difference between the first and second solvents presented in the above. However, if the added amount to cause the 10% change of the permittivity difference or the polarity difference between the first and second solvents could not be more explicitly shown after all, then the invention is impracticable. Accordingly, more practicable method and apparatus are described below. The method and apparatus utilizes the conventional data, the data in FIG. 1 and FIG. 2.

FIG. 1 and FIG. 2 are graphically shown in FIG. 3. FIG. 3 shows a conceptual view of solution/separation by temperature change in a combination of solvents that undergoes temperature-dependent reversible solution/separation change. Owing to the temperature change thereof, the phase of the solvent combination changes between a temperature of the point X and a temperature the point Y in the graph, in which the combination of the first and second solvents is in a separation phase at the point X, and at a temperature of the point Y higher than that of the point X, the combination of the first and second solvents is in a solution phase. Heretofore, no one had an idea of changing the second solvent composition given on the horizontal axis in FIG. 3 and changing a parameter of the blend ratio of the first and second solvents, during a chemical reaction process. In other words, in designing a solvent set, the parameter of the blend ratio of the first and second solvents and the second solvent composition were preset and fixed, and solution/separation change was controlled by temperature control in carrying out a chemical reaction process.

On the other hand, the phase change in the present invention is shown in FIG. 4. The phase of the solvent set changes between a temperature of the point X and a temperature the point Z in the graph, in which the combination of the first and second solvents is in a separation phase at the point X, and at the point Z, the combination of the first and second solvents has a different solvent composition and a different blend ratio from those at the point X and is in a solution phase. The second solvent composition given on the horizontal axis of the graph is changed during a chemical reaction process. Accordingly, the phase change between solution phase and separation phase is thereby controlled. The right-going and left-going arrow in FIG. 4 indicates the phase change of the solvent set. This is a novel concept that could not be readily derived from the conventional concept (FIG. 3). The relevancy between the permittivity and the polarity mentioned above is described. Specifically, the second solvent composition change on the horizontal axis or the blend ratio change in mixing the first and second solvents changes the permittivity difference or the polarity difference between the first and second solvents, like the temperature change of the solvent set.

Real-time detection (real-time monitoring) of the permittivity or the polarity of a solvent is difficult at present, as so mentioned hereinabove. It may be interpreted that, in the prior patent applications, the real-time monitoring is indirectly carried out by temperature. Similarly, the concept of FIG. 4 gives a novel method of real-time monitoring of permittivity or polarity. Specifically, this means that the temperature in the prior patent applications is substituted with the solvent composition/blend ratio.

If real-time detection (real-time monitoring) of the permittivity or the polarity of a solvent is available, then extremely suitable solution/separation control may also be realized. An apparatus may be designed, which is to determine a permittivity or polarity as a control value and to control, based on the measured data, a solution/separation phase as an object to be controlled in a closed loop. At present, however, it is an open loop.

The temperature change in the prior inventions is only one condition to induce a solution/separation phenomenon. An essential condition that includes it is a permittivity or polarity change of a solvent, and it is believed that this may describe the solution/separation phenomenon including temperature. Though in an open loop, the composition change of the second solvent or the blend ratio change in the first and second solvents could induce the phenomenon. This is the method and the apparatus of the third and the following aspects of the invention.

FIG. 5 is a conceptual view of a method of a combination of the present invention and a prior invention. Briefly, this is a method including both temperature change and solvent composition/blend ratio change. The solvent set undergoes repeated change between solution phase and separation phase, from the phase start point V1 of a separation phase of a combination of first and second solvents to the phase point W1 of a solution phase of the combination of first and second solvents through temperature change and solvent composition/blend ratio change, then to the phase start point V2 of a solution phase of the combination of first and second solvents, and further to the phase point W2 of a separation phase of the combination of first and second solvents through temperature change and solvent composition/blend ratio change.

This may be realized in an apparatus comprising a heating and cooling unit of a prior patent application (Japanese Patent Application No. 2002-198242), but the apparatus could be simpler and more practicable when the temperature of the substance such as solvent to be added thereto is at a relatively high or low temperature. This indicates temperature change by substance addition for changing the solvent composition/blend ratio.

The substance such as solvent to be added may be a gas having high heat energy or may be a frozen solid (ice) having low heat energy. The expression of substance such as solvent is meant to indicate that the substance added in the method of FIG. 5 may be a “third” substance except the substances that constitute the solvent set. In other words, the additive substance may be a solute of the first and second solvents, and further the “third” additive substance may be a gas or a frozen solid (ice).

<Problem that the Invention is to Solve in Combinatorial Chemistry>

The problem that the invention is to solve is supplemented herein. This is a problem with an automatic liquid supply and synthesis apparatus used in combinatorial chemistry. FIG. 6 is an explanatory view of the effect and the motion of an automatic liquid supplier used in combinatorial automatic synthesis. FIG. 7 is a time chart showing the heating motion of a mixture of two liquids, A and B supplied by the liquid supplier of FIG. 6.

A conventional method is referred to herein for combinatorial chemical synthesis, in which a solvent set is heated (its container is heated) to attain phase change from separation phase to solution phase. FIG. 8 is a liquid supplier time chart showing a mode of mixing and heating two liquids A and B. In the liquid supplier time chart showing a mode of mixing and heating two liquids A and B, for example, it is understood that mix1 (the time taken from after the mixing of liquids A and B in the first reactor to before the start of heating the reactor) differs from mix2 (the time taken from after the mixing of liquids A and B in the second reactor to before the start of heating the reactor). This is because the apparatus that holds plural reactors therein is heated all at a time, therefore causing the time lag as above.

The time lag is problematic. Specifically, the fact that mix1 and mix2, which are the pre-reaction preparation time before main reaction in combinatorial automatic synthesis, differ from each other is unsuitable since the reaction conditions in the individual reactors are not unified. In other words, the fact that the time, mix-n, to be taken from mixing to start of reactor heating fluctuates for every container is unsuitable. The same shall apply to the time, MIXn, to be taken from after mixing to “finish” of reactor heating (FIG. 9). FIG. 9 indicates a problem with the liquid supplier time chart showing a mode of mixing and heating two liquids A and B, in which, for example, MIX1 (the time taken from after the mixing of liquids A and B in the first reactor to before the finish of heating the reactor) differs from MIX2 (the time taken from after the mixing of liquids A and B in the second reactor to before the finish of heating the reactor). Needless-to-say, disposing a unit for individual reactor temperature control in the apparatus may solve the problem, which, however, is extremely expensive. This is impracticable since the number of the reactors is on an order of hundreds.

The present invention is free from the problems of FIG. 8 and FIG. 9. FIG. 10 describes it. In the invention, two liquids A and B are first mixed in a liquid supplier and then a liquid C (substance C) is added thereto to attain a solution phase, as in the time chart of FIG. 10. Accordingly, the solvent in every reactor is solubilized and the reaction starts at the addition time, and therefore the preparation time before the reaction, ABn and BCn can be controlled to be constant.

(Third and Fourth Aspects of the Invention)

The third and fourth aspects of the invention are a method for solubilization or, contrary to it, for separation through change of the blend ratio of the constitutive elements of the second solvent and/or the blend ratio (graph parameter) of the first and second solvents, in the absence of temperature change, or that is, under a constant temperature condition like that of the horizontal arrow in FIG. 4. Specifically, this is a method for solubilization or, contrary to it, for separation in phase change from the separation phase point in the shadowed zone in FIG. 4 to the solution phase point in the non-shadowed zone, through addition of a corresponding solvent to the solvent set.

Specifically, the third aspect of the invention is a method for solubilization at a constant temperature, which comprises comparing the blend ratio r12(A) of the first and second solvents and the composition blend ratio rA of the second solvent for phase solution/separation at a critical temperature of A-point on the data graph, TA, with the blend ratio r12(B) of the first and second solvents and the composition blend ratio rB of the second solvent for phase solution/separation at a critical temperature of B-point on the data graph, TB that is lower than TA, and adding the first solvent and/or a solvent of constituting the second solvent to the set in order that the blend ratio r12(A) of the first and second solvents and the composition blend ratio rA of the second solvent for phase solution/separation at TA may be the blend ratio of the first and second solvents and the composition blend ratio of the second solvent for phase solution/separation at TB lower than TA, to thereby make the first and second solvents, which are in a separation phase at a constant temperature lower than TA and higher than TB and which undergo phase solution/separation at TA, solubilize at a constant temperature lower than TA and higher than TB.

The above claim applies to every horizontal transfer between two phase points in the shadowed zone and the non-shadowed zone of the graph of FIG. 4. A point to further notice is that the phase change is not limited to the horizontal transfer as in FIG. 4. In other words, the phase change may be for any inclined transfer that crosses the critical temperature line of dividing the shadowed zone and the non-shadowed zone in FIG. 4.

The fourth aspect of the invention is, contrary to the third aspect, a method of phase separation of changing from the non-shadowed zone in FIG. 4 (solution phase point) to the shadowed zone (separation phase point). Its description is omitted since the method is a mere modification of the third aspect of the invention.

Now, when a phase start point is given in FIG. 4 and when the phase change starts from that start point, then the “practicable transfer” for it is taken into consideration. As will be understood from the comparison between FIG. 1 and FIG. 2, the horizontal transfer requires both the second solvent composition blend ratio change on the horizontal axis and the blend ratio change of the first and second solvents (graph parameter). It is troublesome. Accordingly, while the latter blend ratio of the first and second solvents (graph parameter) is kept constant, changing only the blend ratio of the constitutive elements of the second solvent will be preferable for simplifying the calculation of the addition amount. The arrows in FIG. 12 indicate it. In the drawing, T0 shows a constant temperature lower than TA and higher than TB.

At a glance, the arrows in FIG. 12 may be misunderstood to ignore the condition of “constant temperature”, which, however, is not correct. Specifically, FIG. 12 and FIG. 4 differ in the valid points on the graph and, in addition, they. further differ in the meaning of the vertical axis temperature. Regarding the former, only the condition that the blend ratio (graph parameter) of the first and second solvent is kept constant is for the valid points on the graph.

Regarding the latter, every temperature is valid in FIG. 4, but in FIG. 12, the temperature is a parameter and only one temperature condition is valid. (The same shall apply to FIG. 13 and the others. In particular, of the vertical axis temperature, “only one constant temperature” lower than TA of the dotted line and higher than TB has a meaning. In this point, FIG. 12 must not be confused with FIG. 3, FIG. 4 and FIG. 5 in which every vertical axis temperature has a meaning.)

In inclined transfer in FIG. 12, the addition amount calculation is tried. Specifically, under the condition that the blend ratio of the first and second solvents (graph parameter) is constant, or that is, under the condition of r12(A)=r12(B), the addition amount of the first solvent, delta Q1 and the addition amount of the second solvent, delta Q2 are obtained.

Two additional amounts are further defined herein. One is temperature data of the maximum temperature change range, T-range of the solution/separation critical temperature obtained through maximum limit change of the composition blend ratio of the second solvent; and the other is a temperature difference between the preset TA and TB, allowance temperature delta-T. These are defined as T-range and delta-T. The former T-range is substantially an information amount relating to the solution/separation critical temperature of the first and second solvents. In other words, it is a change range of the solution/separation critical temperature when the second solvent composition on the horizontal axis in FIG. 4 and others is varied within a full range (from 0% to 100% of one solvent). This may be one typical value of the solution/separation characteristics of the noted solvent set.

Any other amount except the variable T-range may be introduced. Since the second solvent composition dependency of the solution/separation critical temperature has linearity, it may be, for example, the graph inclination of “solution/separation critical temperature change ratio to the second solvent composition change” as in FIG. 4 and others.

The variable T-range or the above-mentioned change ratio means the data in the wording “based on the data of the solution/separation critical temperature relative to the blend ratio of the first solvent and the second solvent and the composition blend ratio of the second solvent”.

Another value defined herein, allowance temperature delta-T is a preset value. Though not strictly, this value is described with reference to FIG. 4. This is a value of the degree of the vertical axis temperature difference between the crossing of the vertical line running vertically upward from the point A and the solution/separation critical temperature line of the noted solvent set, and the crossing of the vertical line running vertically downward from the point B and the solution/separation critical temperature line.

Similarly, the allowance temperature delta-T is described with reference to FIG. 12. This is the vertical axis temperature difference between the point A and the point B. The meaning of the preset value is that, when the present invention is applied to some chemical reaction, the allowance temperature range ensures safety allowance corresponding to the expected inevitable temperature change of the reaction system. It is difficult to produce a strictly temperature-constant condition in a practical reaction system because of the influence of the environmental temperature thereon. The allowance temperature delta-T is preset, covering the temperature fluctuation. Accordingly, it should be determined in consideration of the object process to be carried out and the field condition.

The point A is in a solution phase at a constant temperature lower than TA and higher than TB; and the point B is in a separation phase at a constant temperature lower than TA and higher than TB. Starting from the point A, a phase change from solution phase to separation phase is investigated, which is from the point A to the point B at a constant temperature (lower than TA and higher than TB).

(Fifth Aspect of the Invention)

As in FIG. 12, it is obvious that, from the T-range data and the preset delta-T, the goal point B from the start point A is determined. FIG. 12 leads to an established proportional relationship of T-range:1=delta-T: (rB-rA). This immediately gives the following expression (1). Not using T-range in this, the line inclination indicating “the solution/separation critical temperature change ratio relative to the second solvent composition change” may also be used to obtain the same relational expression, from which rB may be obtained. (1)

$$rB = \frac{ T}{Trange} + rA \qquad ( 1 )$$

rB is thus obtained, and it leads to an expression to give the addition amount of the first solvent, delta-Q1 and the addition amount of the second solvent, delta-Q2 from the solvent condition at the start point A: the amount of the second solvent Q2(A), r12(A) and rA.

(Sixth Aspect of the Invention)

Naturally, when the composition blend ratio of the second solvent is changed from rA to rB, then it is meaningless to “add both the two second solvents” that constitute the second solvent. In other words, the addition amount of one of the constitutive solvents of the second solvent is zero and its amount does not change before and after the phase change from the point A to the point B.

From the above, (1−rA)*Q2(A)=(1−rB)*Q2(B). In this, the addition (increase) amount of the other constitutive solvent of the second solvent is rB*Q2(B)−rA*Q2(A). From these expressions, the addition amount of the second solvent, delta-Q2 is represented by the following expression (2). Since r12(A)=r12(B), this may be represented by r12(r12(A)=r12(B)=r12), and the following expression (3) may be given to the addition amount of the first solvent, delta-Q1.

$${Q}_{2} = \frac{rB - rA}{1 - rB} \cdot {Q}_{2} ( A ) \qquad ( 2 )$$

$${Q}_{1} = r 12 \cdot \frac{rB - rA}{1 - rB} \cdot {Q}_{2} ( A ) \qquad ( 3 )$$

(Seventh Aspect of the Invention)

Contrary to the above, a phase change from the start point B to the point A is investigated. This is a phase change from solution phase to separation phase. The seventh aspect of the invention logically states the method. The point B is in a separation phase at a constant temperature lower than TA and higher than TB; and the point A is in a solution phase at a constant temperature lower than TA and higher than TB. rA is obtained according to the following expression (4) derived from the expression (1).

$$rA = rB - \frac{ T}{Trange} \qquad ( 4 )$$

(Eighth Aspect of the Invention)

Like in the case of from the point A to the point B, since adding both of the two solvents of the second solvent is meaningless, the “other” constitutive solvent of the second solvent is not added, contrary to the case of from the point A to the point B. Accordingly, rA*Q2(A)=rB*Q2(B). In this, the addition (increase) amount of one constitutive solvent of the second solvent is (1−rA)*Q2(A)−(1−rB)*Q2(B). From these expressions, the addition amount of the second solvent, delta-Q2 is represented by the following expression (5). The condition of r12(A)=r12(B) is typically represented by r12 (r12(A)=r12(B)=r12), and the addition amount of the first solvent, delta-Q1 is represented by the following expression (6).

$$\begin{matrix} {Q}_{2} = \frac{rB - rA}{rA} \cdot {Q}_{2} ( B ) & ( 5 ) \\ {Q}_{1} = r 12 \cdot \frac{rB - rA}{rA} \cdot {Q}_{2} ( B ) & ( 6 )\end{matrix}$$

In the above, the blend ratio of the first and second solvents (graph parameter) is constant, or that is, under the condition of r12(A)=r12(B), the addition amount computation is simplified. Other conditions than the condition of r12(A)=r12(B) are investigated hereunder. One condition is that the composition blend ratio rC of the second solvent of the first and second solvents for solution/separation at TC is equal to the composition blend ratio, rd of the second solvent of the first and second solvents for solution/separation at Td (rC=rd=r). This is graphed in FIG. 13. In the drawing, the vertical arrows show the change in rC=rd (=r). In this, T0 indicates a constant temperature lower than TC and higher than Td.

In this, a function, f, is defined. A function for inducing the solution/separation critical temperature T from the blend ratio of the first and second solvent (e.g., r12(C), r12(d)) is represented by f(r12). An inverse function to f(r12) is defined. Specifically, a function for inducing the blend ratio r12 of the first and second solvents from the solution/separation critical temperature T is represented by f⁻¹(T). FIG. 15 shows an explanatory view of the function f(r12) and the inverse function f⁻¹(T).

With reference to the data of the solution/separation critical temperature T relative to the composition blend ratio r12 as in FIG. 1 and FIG. 2, if any, the function and the inverse function may serve as implements in software. For example, a database with a memory of the composition blend ratio r12 and the solution/separation critical temperature data may be constructed in a computer device to build up software for direct reference of data on one side from those on the other side or for interpolation or extrapolation from data. In a simple method, an N-order regression expression of the data of solution/separation critical temperature obtained through (N+1) times measurement may be the function.

(Ninth Aspect of the Invention)

For ensuring the unification between the ninth and eleventh aspects and the other above-mentioned aspects of the invention, A and B are given therein. For simplification herein, however, these are substituted with C and d (A is substituted with C, and B is substituted with d), and expressions (7), (8), (9) and (10) are described with reference to the corresponding expressions (7′), (8′), (9′) and (10′) where A is substituted with C, and B is substituted with d. However, description of these expressions (7′), (8′), (9′) and (10′) is omitted herein, since they are the same as the expressions (7), (8), (9) and (10) except that A is substituted with C and B is substituted with d in the former. (The expressions (7′), (8′), (9′) and (10′) are not individually described since they are the modifications for substitution from the expressions (7), (8), (9) and (10), respectively.)

$$\begin{matrix}r 12 ( B ) = {f}^{- 1} [ f ( r 12 ( A ) ) - T ] & ( 7 ) \\ {Q}_{2} = \frac{r 12 ( A ) - r 12 ( B )}{r 12 ( B ) } \cdot {Q}_{2} ( A ) \\ {Q}_{1} = 0 & ( 8 )\end{matrix}$$

r12(A)=f⁻¹[f(r12(B))− [symbol] T] (9) [symbol]
Q₁=[r12(A)−r12(B)]·Q₂(B) [symbol]
Q₂=0 (10)

The composition blend ratio, rC, of the second solvent of the first and second solvents for solution/separation at TC is set equal to the blend ratio, rd, of the second solvent of the first and second solvents for solution/separation at Td (rC=rd), and the function f(r12) for obtaining the solution/separation critical temperature from r12 and the inverse function f⁻¹(T) to f(r12) for obtaining r12 from the solution/separation critical temperature are defined, based on the solution/separation critical temperature data of the solvent set of the type.

In phase change from solution phase at the point C to separation phase at the point d, the blend ratio r12(d) of the first and second solvents for solution/separation at Td may be obtained according to the expression (7′) from the temperature difference between the preset TC and Td, allowance temperature delta-T, and the blend ratio r12(C) of the first and second solvents for solution/separation at TC. This is obvious from FIG. 15.

(Tenth Aspect of the Invention)

In phase change from solution phase at the point C to separation phase at the point d, the amount of the second solvent must be relatively increased. Accordingly, the amount of the first solvent is not changed. This leads to r12(C)*Q2(C)=r12(d)*Q2(d). In this relational expression, the addition amount of the second solvent, delta-Q2=Q2(d)-Q2(C) is substituted to give the expression (8′). r12(d) is obtained from the expression (7′), and the addition amount of the second solvent delta-Q2 is obtained in the expression (8′). Naturally, the addition amount of the first solvent, delta-Q1 is zero.

(Eleventh Aspect of the Invention)

In phase change from separation phase at the point d to solution phase at the point C, contrary to the above, the blend ratio r12(C) of the first and second solvents at the point C is obtained according to the expression (9′) modified from the expression (7′).

(Twelfth Aspect of the Invention)

In phase change from separation phase to solution phase, the amount of the first solvent must be relatively increased. Accordingly, the amount of the second solvent is not changed. This means Q2(C)=Q2(d). In this relational expression, the addition amount of the second solvent, delta-Q2=r12(d)*Q2(d)−r12(C)*Q2(C) is substituted to give the expression (10′). Naturally, the addition amount of the second solvent, delta-Q2 is zero.

<Computation Example>

Phase change from solution phase at the point A to separation phase at the point B is investigated with the blend ratio r12 of the first and second solvents kept constant as first/second solvent= 1/10. rA is 4/10. From given data of T-range and delta-T, rB is computed as 5/10 according to the expression (1). The amount of the second solvent at the start point A is 10 ml. In this case, one constitutive solvent of the second solvent is 4 ml and the other is 6 ml. In this case, it is obvious that one constitutive solvent of the second solvent (4 ml) is increased.

From the expression (2), the addition amount of the first solvent, delta-Q1 is ( 1/10)*(( 5/10)−( 4/10))/(1−( 5/10))*10=0.2 ml; and from the expression (3) the addition amount of the second solvent, delta-Q2 is (( 5/10)−( 4/10))/(1−( 5/10))*10=2.0 ml.

<Non-Addition of First Solvent>

FIG. 14A is a solution/separation critical temperature (vertical axis) data graph relative to the composition blend ratio (horizontal axis) of the second solvent with a parameter of the blend ratio of a typical example of the low-polarity first solvent, cyclohexane. In this, when the blend ratio of cyclohexane is large (for example, when it is 1:20 or more), then the data graph is not shifted even though the parameter is changed (the graph is dense). Where the blend ratio is in such a case, the addition amount of the first solvent, delta-Q1 may be neglected and the first solvent may not be added without causing any serious problem. FIG. 14B shows it concretely.

FIG. 14B shows a case of phase change from the start point A at which the blend ratio of first and second solvents r12=100 (first/second solvent=100), the first solvent is 1000 ml, the second solvent is 10 ml, and like in the above-mentioned example, one constitutive solvent of the second solvent is 4 ml and the other is 6 ml, and rA is 4/10, to the goal point B at which rB is 5/10. In this, the addition amount of one constitutive component of the second solvent, delta-Q2, is 2.0 ml according to the expression (3), like in the previous case. On the other hand, the addition amount of the first solvent, delta-Q1 is, ( 1/10)*(( 5/10)−( 4/10))÷(1−( 5/10))*1000=20 ml, according to the expression (2).

In this, the necessary addition amount of the first solvent delta-Q1=200 ml is omitted, and it is 0 ml. Then, the phase changes to the point B′ in FIG. 14B. In this stage, the first solvent is 1000 ml and the second solvent is 12 ml, and therefore the parameter of the point B′, the blend ratio r12 of the first and second solvents is 1000/12=83.3. Qualitatively, the graph shift of the blend ratio r12=100 (first/second solvent=100) and the blend ratio r12=83.3 (first/second solvent=83.3) is small, and the vertical axis temperature difference is also small.

Comparing the allowance temperature delta-T and the solution/separation critical temperature (vertical axis) data (FIG. 14B) and investigating them will be needed. However, the solution/separation critical temperature difference resulting from the difference roughly between r12=100 and r12=83.3 could be a small temperature difference relative to the allowance temperature delta-T. Accordingly, even when the addition amount of the first solvent delta-Q1 is neglected and the first solvent is not added, then it may not produce any serious problem.

In the case where the addition amount of the first solvent is omitted, the blend ratio r12 of the first and second solvents may be computed from rB and rA. It is r12*(1−rB)÷(1−rA). When applied to the previous example, then it leads to 100*(1−( 5/10))÷(1−( 4/10))=83.3.

(Thirteenth Aspect of the Invention)

An application method of a substance capable of significantly changing the solution/separation critical temperature of a solvent set when only a minor amount thereof is added to the set, such as typically alkyl carbonate, is described (claim 13). FIG. 11 is a solution/separation critical temperature data graph of a case where a mixture of DMI (dimethylimidazolidinone) and carbonate is used as the second solvent. The horizontal axis of this graph indicates the direction in which the compositional amount of carbonate is relatively decreased, and the horizontal axis scale is enlarged. Accordingly, as compared with that in FIG. 1 and FIG. 2, the graph inclination in FIG. 11 is extremely steep. This suggests that addition of only a small amount of carbonate to a solvent set in solution phase readily changes the set into separation phase.

It is believed that the substance having the property as in FIG. 11, such as carbonate, may act on the solvent set in solution phase to thereby significantly increase the permittivity difference or the polarity difference between the first and second solvents. The substance of the type is used for phase separation in the solvent set of a combination of a combination of a first solvent and a second solvent of a mixture of plural solvents, which undergoes temperature-dependent reversible change between solution phase and separation phase, after the solvent set has been processed at least once for solubilization of the first solvent and the second solvent of a mixture of plural solvents.

The method of this aspect is for phase separation after the solubilization process by adding a substance except the first and second solvents to the solubilized solution as a result of the solubilization process to thereby induce phase change from solution phase to separation phase in the absence of temperature change, and the method comprises adding an additive substance to a combination of a mixture resulting from addition of the additive substance to the second solvent of a single solvent or a mixture of plural solvents and the first solvent, to such a degree that the addition of the additive substance to the second solvent in an amount of 10% by volume of the second solvent changes the solution/separation critical temperature of the solvent set by at least 10 degrees, thereby attaining the phase change into separation phase at a constant temperature.

(Fourteenth Aspect of the Invention)

Though repeatedly described herein, an example of the additive substance in claim 13 is a carbonate, and an alkyl carbonate illustrated in FIG. 11 is especially preferred. In general, it is desirable that the additive substance in claim 13 is a solid substance and preferably, the permittivity of the solution with the additive substance added thereto is at least 20 or the polarity thereof (ET30) is at least 25.

In the above description, the second solvent is comprised of two solvents and is a mixture of two solvents. The same as in the case may apply to other cases where the second solvent is comprised of three or more solvents. Two of the three or more solvents constituting the second solvent are noted, and the amount of the others constituting the second solvent is fixed. Concretely, employed is a graph of solution/separation critical temperature data, in which the horizontal axis indicates the composition blend ratio of the noted two solvents, and in these data, the amount of the other solvent components constituting the second solvent is fixed.

Accordingly, the number of the three or more solvents is represented by N, and of those, the solution/separation critical temperature data of the number except the two noted solvents, or that is, the number of the combinations derived by subtracting 2 from N (_{N}C₂) are collected. The most suitable combination is selected from these, and to only the thus-selected solvent, the operation for solution/separation of the invention is applied. Needless-to-say, since the amount of the other solvents constituting the second solvent is a variable, the number of the combinations shall be large. It is desirable that an evaluation function of the solvent cost and others is preset and the computation is effected in a mode of optimization algorithm to give the extreme value of the evaluation function, thereby determining the addition action.

(Fifteenth to Eighteenth Aspects of the Invention)

Apparatuses for the method of the invention are described below. FIG. 16 is an explanatory view of an apparatus of the invention, especially the operation block thereof (from A to B; r12 constant); FIG. 17 is an explanatory view of an apparatus of the invention, especially the operation block thereof (from B to A; r12 constant); FIG. 18 is an explanatory view of an apparatus of the invention, especially the operation block thereof (from C to d; r constant); FIG. 19 is an explanatory view of an apparatus of the invention, especially the operation block thereof (from d to C; r constant).

The fifteenth aspect of the invention is an invention of an apparatus for the method of the first, third and fourth aspects of the invention, and FIG. 16 illustrates it. The sixteenth aspect of the invention is an invention of an apparatus for the method of the second, fifth and sixth aspects of the invention, and FIG. 17 illustrates it. The seventeenth aspect of the invention is an invention of an apparatus for the method of the first, seventh and eighth aspects of the invention, and FIG. 18 illustrates it. The eighteenth aspect of the invention is an invention of an apparatus for the method of the second, ninth and tenth aspects of the invention, and FIG. 19 illustrates it.

In FIG. 16 to FIG. 19, 1 is an operation block with an operation unit for the expression (1) or (11); 2 is an operation block with an operation unit for the expression (2) or (12); 3 is an operation block with an operation unit for the expression (3) or (13); 4 is an operation block with an operation unit for the expression (4) or (14); 5 is an operation block with an operation unit for the expression (5) or (15); 6 is an operation block with an operation unit for the expression (6) or (16); 7 is an operation block with an operation unit for the expression (7), (7′) or (17); 8 is an operation block with an operation unit for the expression (8), (8′) or (18); 9 is an operation block with an operation unit for the expression (9), (9′) or (19); 10 is an operation block with an operation unit for the expression (10), (10′) or (20).

In a combination of a first solvent and a second solvent of a mixture of plural solvents that undergoes temperature-dependent reversible change between solution phase and separation phase, the invention has realized phase change between solution phase and separation phase at a constant temperature with no temperature change. The heat capacity of a reactor in a mass-production process is large, and much energy is needed for the temperature change of the reactor. The present invention does not require the energy, and it is significantly effective for energy-saving. Another advantage of the invention is that, in carrying out a large number of similar reactions in automatic synthesis in combinatorial chemistry, the time condition before each reaction to be unified may be readily kept constant in the invention.

The fifteenth aspect of the invention is an apparatus for solubilization of a solvent set of a combination of a first solvent and a second solvent of a mixture of plural solvents, which undergoes temperature-dependent reversible change between solution phase and separation phase and which is in a separation phase, wherein the composition blend ratio of the second solvent of the solvent set of the first and second solvents, of which the solution/separation critical temperature is represented by TA, the blend ratio of the first and second solvents is by r12, the second solvent amount is by Q2(A) and the blend ratio of any two constitutive components of the second solvent is by rA, is changed to a composition blend ratio, rB of the second solvent of the combination of the first and second solvents, of which the solution/separation critical temperature is TB that is lower than TA by the allowance temperature delta-T for the preset solution/separation critical temperature thereof and the blend ratio of the first and second solvents is the same as above and is r12, by adding the first and second solvents to the solvent set on the basis of the solution/separation critical temperature data relative to the blend ratio of the first solvent and the second solvent and to the composition blend ratio of the second solvent, to thereby solubilize the separation-phase solvent set of a combination of the first and second solvents; the apparatus comprising an initial data-inputting unit for inputting the data rA and Q2(A), a presetting and inputting unit for the allowance temperature delta-T, a database reference unit of taking thereinto the data of the maximum temperature change range, T-range of the solution/separation critical temperature obtained through maximum limit change of the composition blend ratio of the second solvent in the solvent set of a combination of the first and second solvents of which the blend ratio of the first and second solvents is r12, from a solution/separation critical temperature database, an operation unit for obtaining rB from the values of delta-T, T-range and rA according to the following expression (11), an operation unit for obtaining the addition amount delta-Q1 of the first solvent from the values of rB obtained in the above operation unit, and rA and Q2(A) according to the following expression (13), and an operation unit for obtaining the addition amount delta-Q2 of the second solvent according to the following expression (12):

$$\begin{matrix}rB = \frac{ T}{Trange} + rA & ( 11 ) \\ {Q}_{2} = \frac{rB - rA}{1 - rB} \cdot {Q}_{2} ( A ) & ( 12 ) \\ {Q}_{1} = r 12 \cdot \frac{rB - rA}{1 - rB} \cdot {Q}_{2} ( A ) & ( 13 )\end{matrix}$$

The sixteenth aspect of the invention is an apparatus for phase separation of a solvent set of a combination of a first solvent and a second solvent of a mixture of plural solvents, which undergoes temperature-dependent reversible change between solution phase and separation phase and which is in a solution phase, wherein the composition blend ratio of the second solvent of the solvent set of the first and second solvents, of which the solution/separation critical temperature is represented by TB, the blend ratio of the first and second solvents is by r12, the second solvent amount is by Q2(B) and the blend ratio of any two constitutive components of the second solvent is by rB, is changed to a composition blend ratio, rA of the second solvent of the combination of the first and second solvents, of which the solution/separation critical temperature is TA that is higher than TB by the allowance temperature delta-T for the preset solution/separation critical temperature thereof and the blend ratio of the first and second solvents is the same as above and is r12, by adding the first and second solvents to the solvent set on the basis of the solution/separation critical temperature data relative to the blend ratio of the first solvent and the second solvent and to the composition blend ratio of the second solvent, to thereby change the solution-phase solvent set of a combination of the first and second solvents into a separation-phase one; the apparatus comprising an initial data-inputting unit for inputting the data rB and Q2(B), a presetting and inputting unit for the allowance temperature delta-T, a database reference unit of taking thereinto the data of the maximum temperature change range, T-range of the solution/separation critical temperature obtained through maximum limit change of the composition blend ratio of the second solvent in the solvent set of a combination of the first and second solvents of which the blend ratio of the first and second solvents is r12, from a solution/separation critical temperature database, an operation unit for obtaining rA from the values of delta-T, T-range and rB according to the following expression (14), an operation unit for obtaining the addition amount delta-Q1 of the first solvent from the values of rA obtained in the above operation unit, and rB and Q2(B) according to the following expression (16), and an operation unit for obtaining the addition amount delta-Q2 of the second solvent according to the following expression (15):

$$\begin{matrix}rA = rB - \frac{ T}{Trange} & ( 14 ) \\ {Q}_{2} = \frac{rB - rA}{rA} \cdot {Q}_{2} ( B ) & ( 15 ) \\ {Q}_{1} = r 12 \cdot \frac{rB - rA}{rA} \cdot {Q}_{2} ( B ) & ( 16 )\end{matrix}$$

The seventeenth aspect of the invention is an apparatus for solubilization of a solvent set of a combination of a first solvent and a second solvent of a mixture of plural solvents, which undergoes temperature-dependent reversible change between solution phase and separation phase and which is in a separation phase, wherein the composition blend ratio of the second solvent of the solvent set of the first and second solvents, of which the solution/separation critical temperature is represented by TA, the blend ratio of the first and second solvents is by r12(A), the second solvent amount is by Q2(A) and the blend ratio of any two constitutive components of the second solvent is by r, is so changed that the blend ratio of any two constitutive components of the second solvent may be the same as above, r (rA=rB) at TB that is lower than TA by the allowance temperature delta-T for the preset solution/separation critical temperature thereof an the blend ratio of the first and second solvents may be r12(B), by adding the second solvent to the solvent set on the basis of the solution/separation critical temperature data relative to the blend ratio of the first solvent and the second solvent and to the composition blend ratio of the second solvent, to thereby solubilize the separation-phase solvent set of a combination of the first and second solvents; the apparatus comprising an initial data-inputting unit for inputting the data r12(A) and Q2(A), a presetting and inputting unit for the allowance temperature delta-T, a database reference unit for referring to a function database having a function f(r12) for obtaining the solution/separation critical temperature of the solvent set with a variable of the blend ratio r12 of the first and second solvents, from the solution/separation critical temperature data of the solvent set of a combination of the first and second solvents in which the blend ratio of any two constitutive components of the second solvent is r, and having an inverse function f⁻¹(T) to f(r12) for obtaining the blend ratio r12 of the first and second solvents with a variable of the solution/separation critical temperature T, and comprising an operation unit for obtaining r12(B) from the values of r12(A) and delta-T according to the following expression (17), and an operation unit for obtaining the addition amount delta-Q2 of the second solvent from the values of r12(B) obtained in the above operation unit, and r12(A) and Q2(A) according to the following expression (18):

$$\begin{matrix}r 12 ( B ) = {f}^{- 1} [ f ( r 12 ( A ) ) - T ] & ( 17 ) \\ {Q}_{2} = \frac{r 12 ( A ) - r 12 ( B )}{r 12 ( B ) } \cdot {Q}_{2} ( A ) \\ {Q}_{1} = 0 & ( 18 )\end{matrix}$$

The eighteenth aspect of the invention is an apparatus for phase separation of a solvent set of a combination of a first solvent and a second solvent of a mixture of plural solvents, which undergoes temperature-dependent reversible change between solution phase and separation phase and which is in a solution phase, wherein the composition blend ratio of the second solvent of the solvent set of the first and second solvents, of which the solution/separation critical temperature is represented by TB, the blend ratio of the first and second solvents is by r12(B), the second solvent amount is by Q2(B) and the blend ratio of any two constitutive components of the second solvent is by r, is so changed that the blend ratio of any two constitutive components of the second solvent may be the same as above, r (rB=rA) at TA that is higher than TB by the allowance temperature delta-T for the preset solution/separation critical temperature thereof an the blend ratio of the first and second solvents may be r12(A), by adding the second solvent to the solvent set on the basis of the solution/separation critical temperature data relative to the blend ratio of the first solvent and the second solvent and to the composition blend ratio of the second solvent, to thereby change the solution-phase solvent set of a combination of the first and second solvents into a separation-phase one; the apparatus comprising an initial data-inputting unit for inputting the data r12(B) and Q2(B), a presetting and inputting unit for the allowance temperature delta-T, a database reference unit for referring to a function database having a function f(r12) for obtaining the solution/separation critical temperature of the solvent set with a variable of the blend ratio r12 of the first and second solvents, from the solution/separation critical temperature data of the solvent set of a combination of the first and second solvents in which the blend ratio of any two constitutive components of the second solvent is r, and having an inverse function f⁻¹(T) to f(r12) for obtaining the blend ratio r12 of the first and second solvents with a variable of the solution/separation critical temperature T, and comprising an operation unit for obtaining r12(A) from the values of r12(B) and delta-T according to the following expression (19), and an operation unit for obtaining the addition amount delta-Q2 of the second solvent from the values of r12(A) obtained in the above operation unit, and r12(B) and Q2(B) according to the following expression (20):
r12(A)=f⁻¹[f(r12(B))− [symbol] T] (19) [symbol]
Q₁=[r12(A)−r12(B)]·Q₂(B) [symbol]
Q₂=0 (20)

### BRIEF DESCRIPTION OF THE DRAWINGS

FIG. 1 shows solution/separation critical temperature data (part 1) relative to the blend ratio of a first solvent and a second solvent (CH:NA (nitroalkane)) and to the composition blend ratio of the second solvent. In this, the first solvent is CH (cyclohexane) and the second solvent is a mixed solvent of NM (nitromethane) and NE (nitroethane).

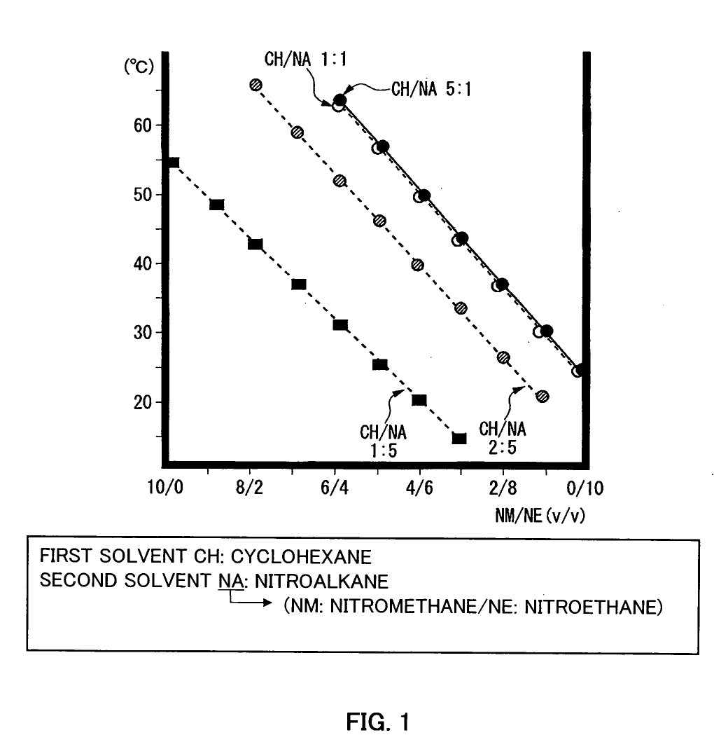

FIG. 2 shows solution/separation critical temperature data (part 2) relative to the blend ratio of a first solvent and a second solvent and to the composition blend ratio of the second solvent. In this, the first solvent is CH (cyclohexane), and the second solvent is a mixture of NM (nitromethane) and NE (nitroethane), or a mixed solvent of AN (acetonitrile) and N (propionitrile), or a mixed solvent of DMF (dimethylformamide) and DMA (dimethylacetamide).

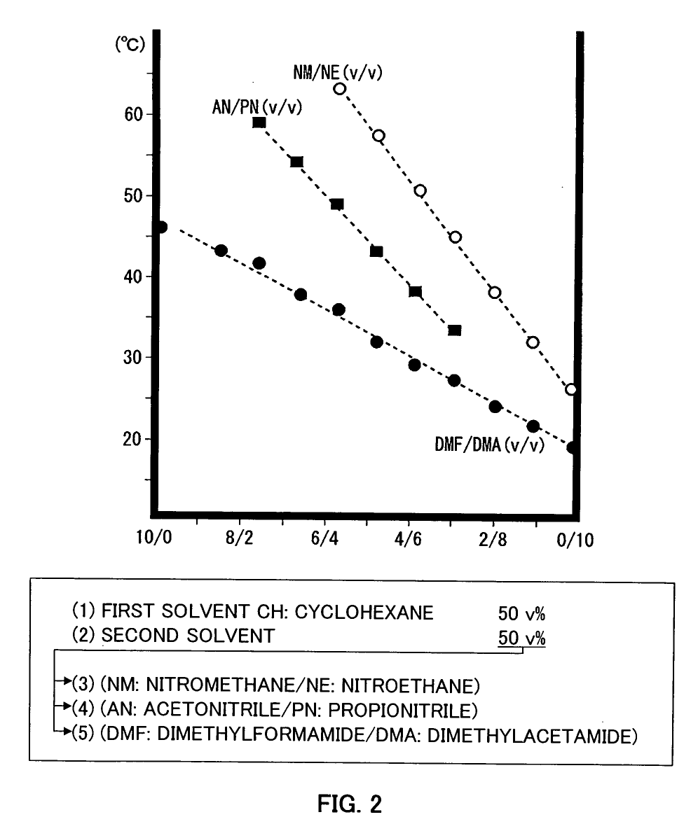

FIG. 3 shows a conceptual view of solution/separation by temperature change in a combination of solvents that undergoes temperature-dependent reversible solution/separation change.

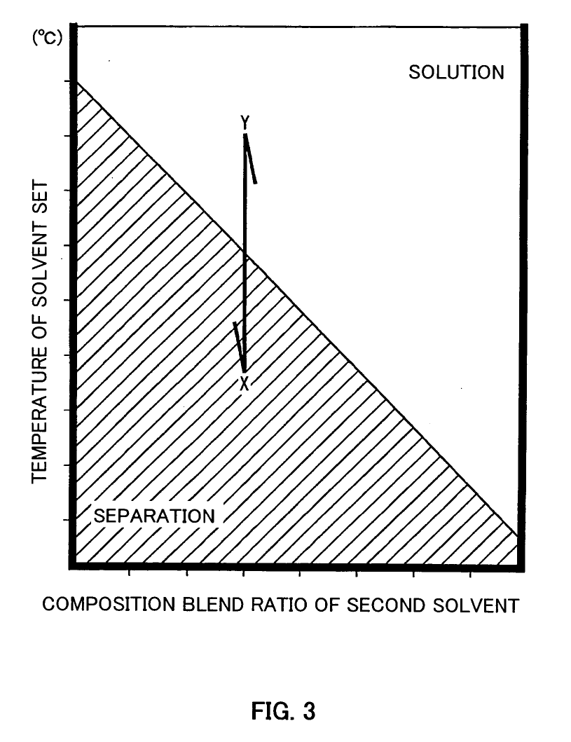

FIG. 4 shows a conceptual view of solution/separation at a constant temperature through change of the composition of a second solvent.

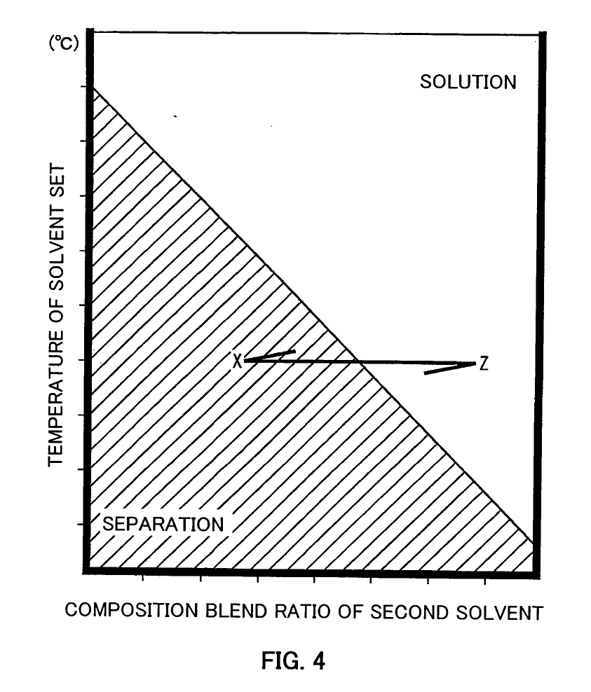

FIG. 5 shows a conceptual view of solution/separation through temperature and composition change.

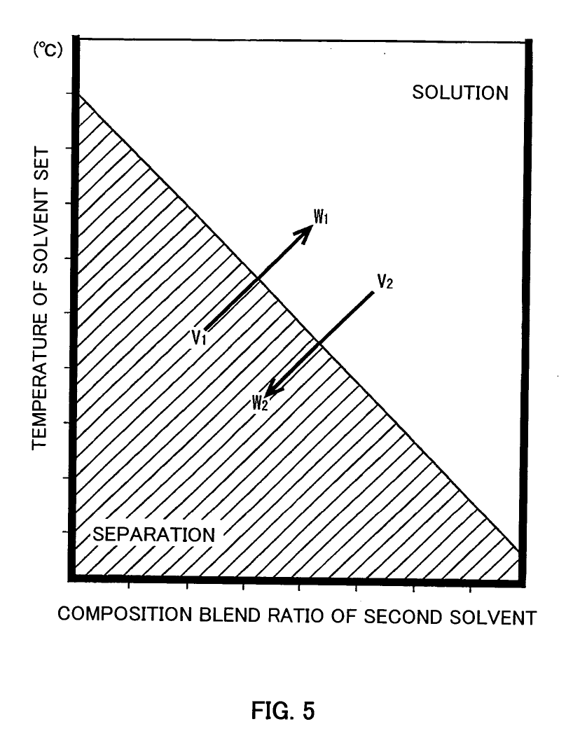

FIG. 6 shows the effect and the motion of an automatic liquid supplier used in combinatorial automatic synthesis.

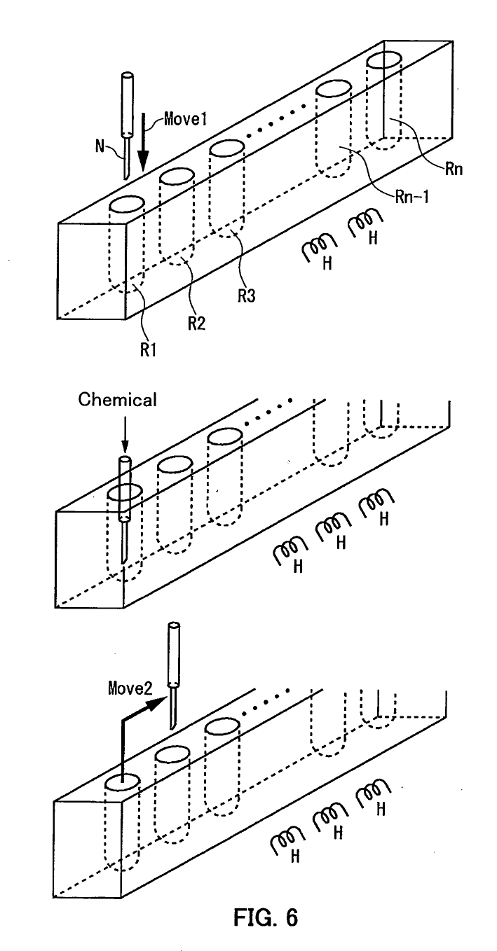

FIG. 7 shows a time chart showing the heating motion of a mixture of two liquids, A and B supplied by a liquid supplier.

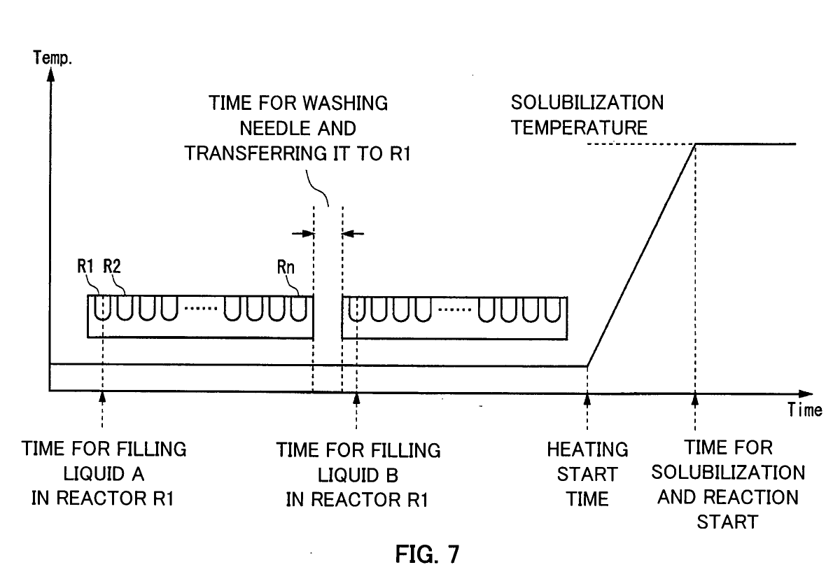

FIG. 8 is a liquid supplier time chart showing a mode of mixing and heating two liquids A and B, indicating a problem in that, for example, mix1 (the time taken from after the mixing of liquids A and B in the first reactor to before the start of heating the reactor) differs from mix-n (the time taken from after the mixing of liquids A and B in the n-th reactor to before the start of heating the reactor).

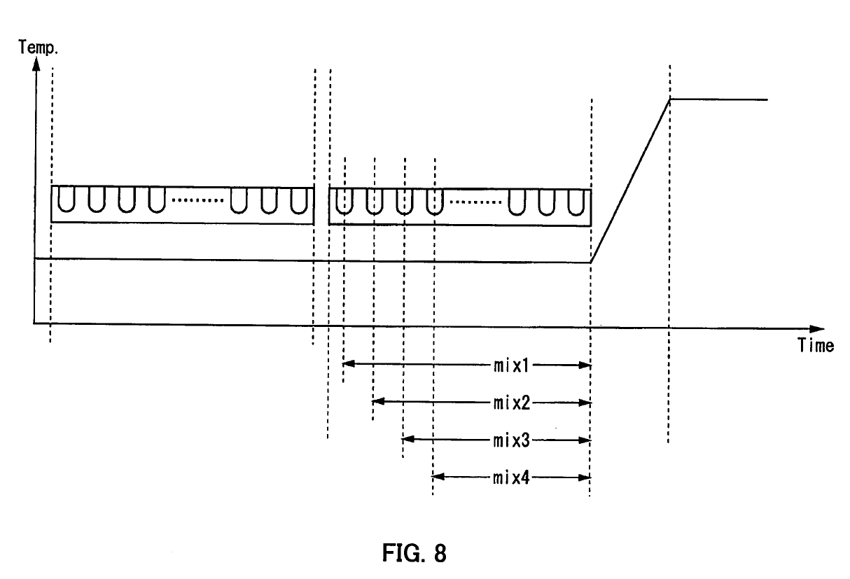

FIG. 9 is a liquid supplier time chart showing a mode of mixing and heating two liquids A and B, indicating a problem in that, for example, MIX1 (the time taken from after the mixing of liquids A and B in the first reactor to before the finish of heating the reactor) differs from MIX2 (the time taken from after the mixing of liquids A and B in the second reactor to before the finish of heating the reactor).

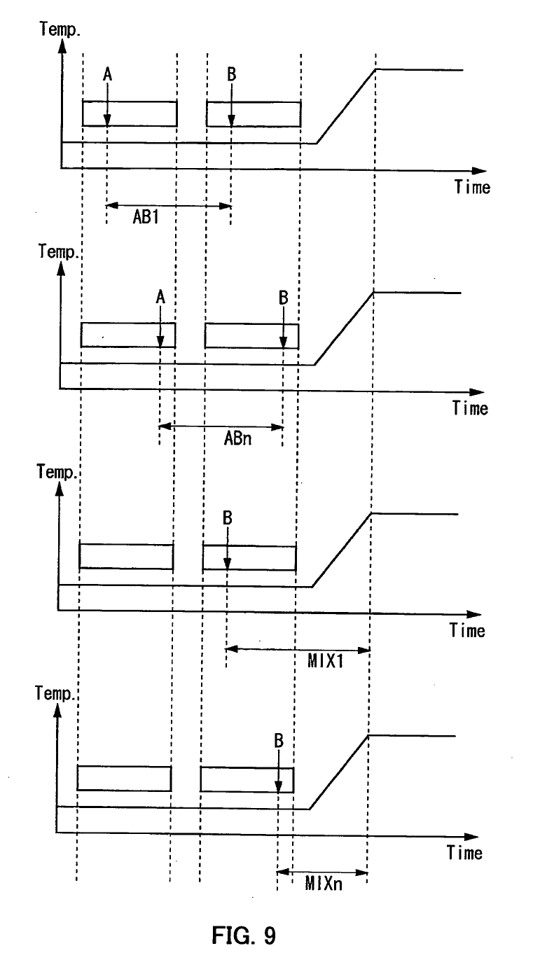

FIG. 10 shows the absence of the problems of FIG. 8 and FIG. 9 in the solubilization/phase separation method of the invention. (Two liquids A and B are mixed in a liquid supplier and then a liquid C (substance C) is added thereto to produce a solution phase before the start of reaction, and therefore the preparation time before the reaction, ABn and BCn is kept constant.)

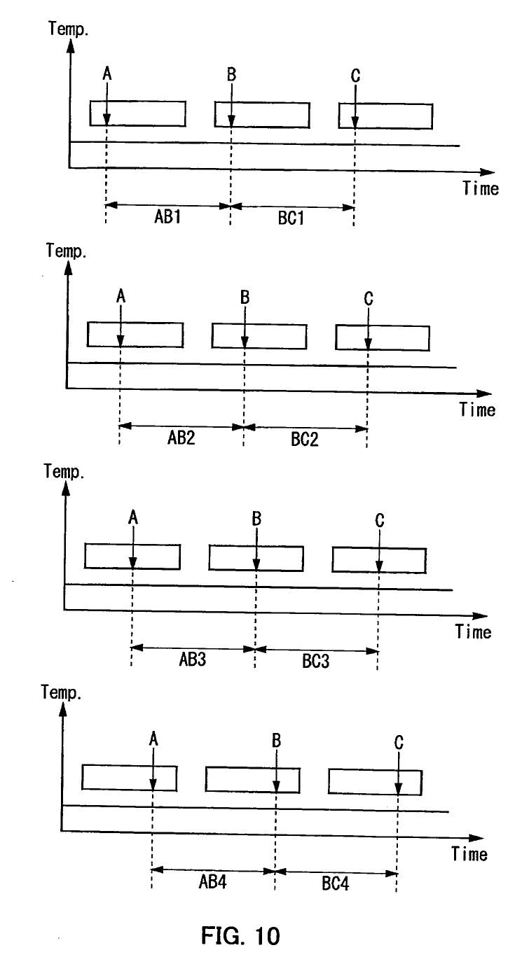

FIG. 11 shows solution/separation critical temperature data of a case where a mixture of DMI (dimethylimidazolidinone) and carbonate is used as a second solvent.

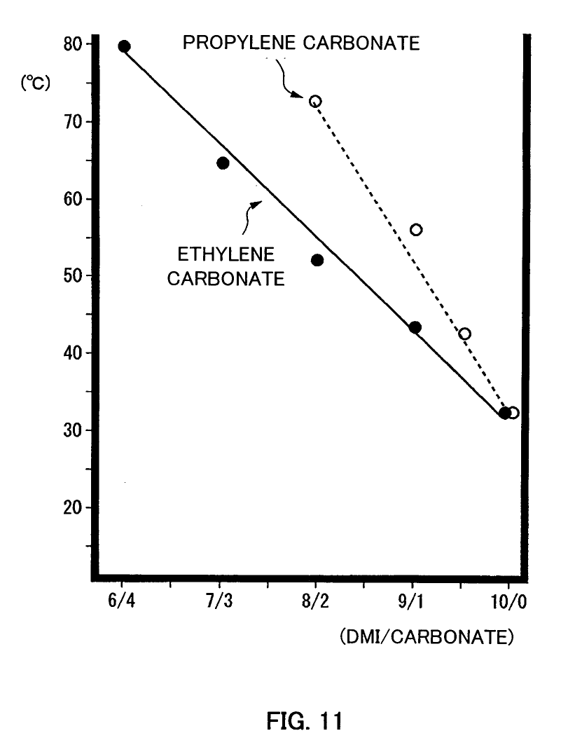

FIG. 12 shows a conceptual view of solubilization of a combination of first and second solvents at a constant temperature lower than TA and higher than TB, by adding a solvent of constituting the first solvent and/or the second solvent to the solvent set so that the combination of the first and second solvents which is in a separation phase at a temperature TA (point A) may have a composition blend ratio thereof at a temperature TB lower than TA (in a case of r12(A)=r12(B)=r12); and phase separation contrary to it.

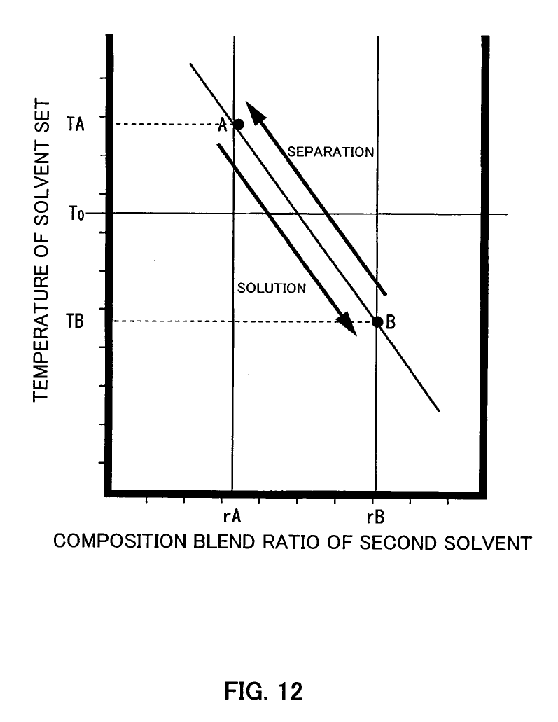

FIG. 13 shows a conceptual view of solubilization of a combination of first and second solvents at a constant temperature lower than TC and higher than Td, by adding a solvent of constituting the first solvent and/or the second solvent to the solvent set so that the combination of the first and second solvents which is in a separation phase at a temperature TC (point C) may have a composition blend ratio thereof at a temperature Td lower than TC (in a case of rA=rB); and phase separation contrary to it.

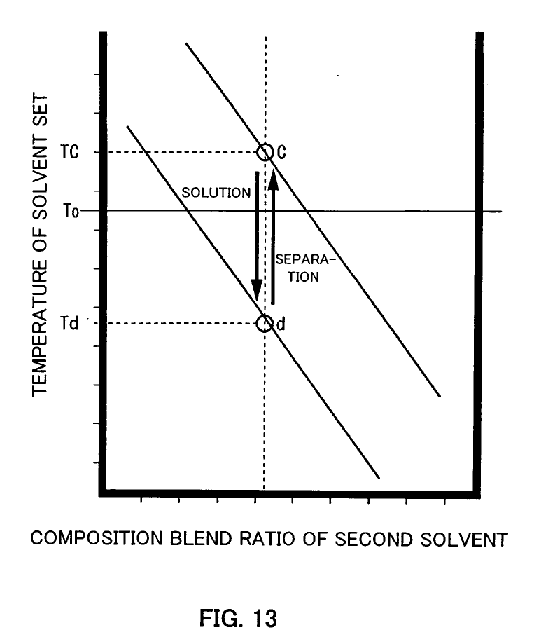

FIG. 14(A) shows that, when the blend ratio of cyclohexane is large (for example, when it is 1:20 or more), then the data graph is not shifted even though the blend ratio of the first and second solvents (parameter) is changed (the graph is dense); FIG. 14(B) shows a change (from A to B′) in a case where addition of cyclohexane is omitted when the blend ratio of cyclohexane is large (1:20 or more).

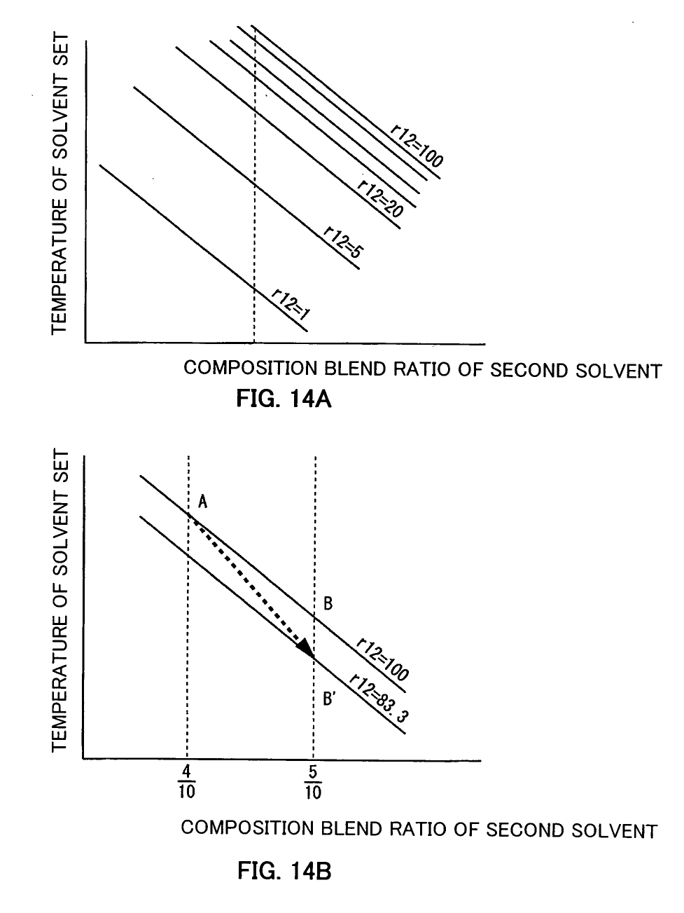

FIG. 15 shows a function f(r12) to derive a solution/separation critical temperature T from a blend ratio r12 of first and second solvents, and an inverse function f⁻¹(T) to the function f.

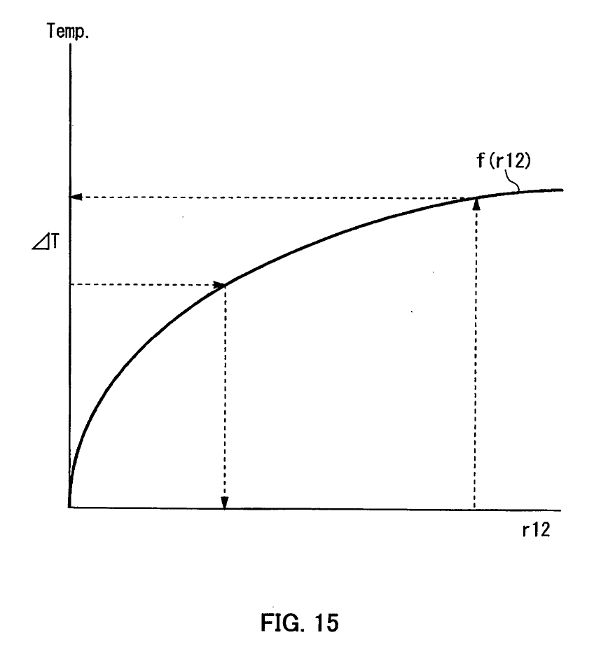

FIG. 16 shows an apparatus of the invention, especially the operation block thereof (from A to B; r12 constant).

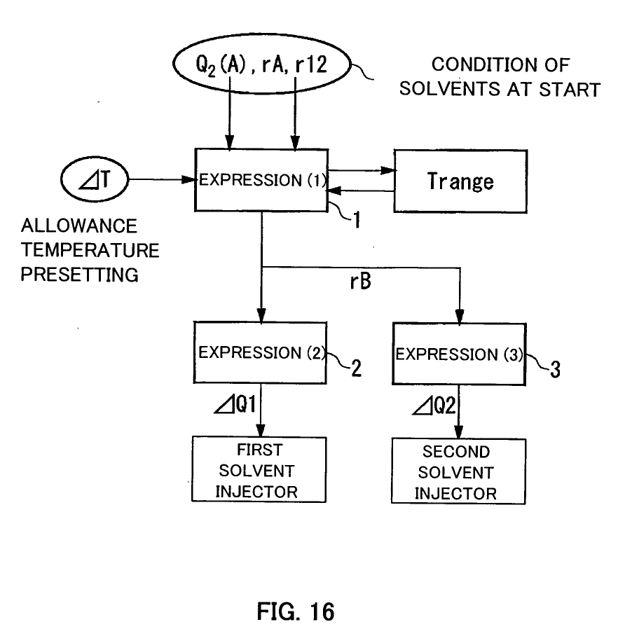

FIG. 17 shows an apparatus of the invention, especially the operation block thereof (from B to A; r12 constant).

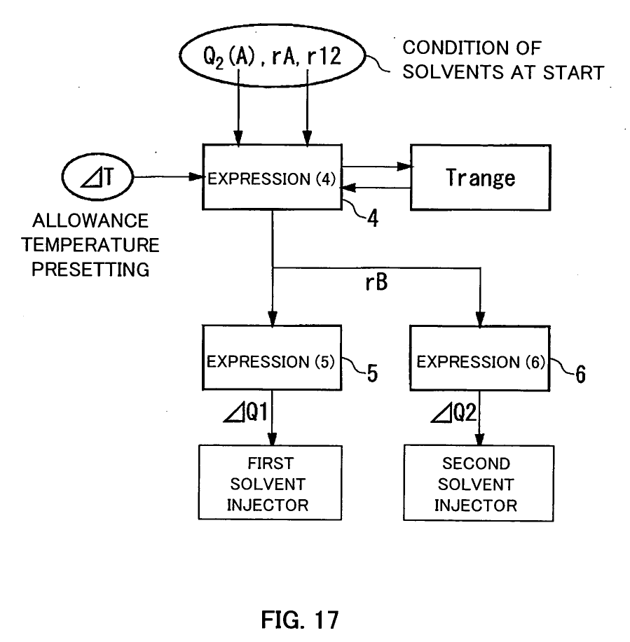

FIG. 18 shows an apparatus of the invention, especially the operation block thereof (from C to d; r constant).

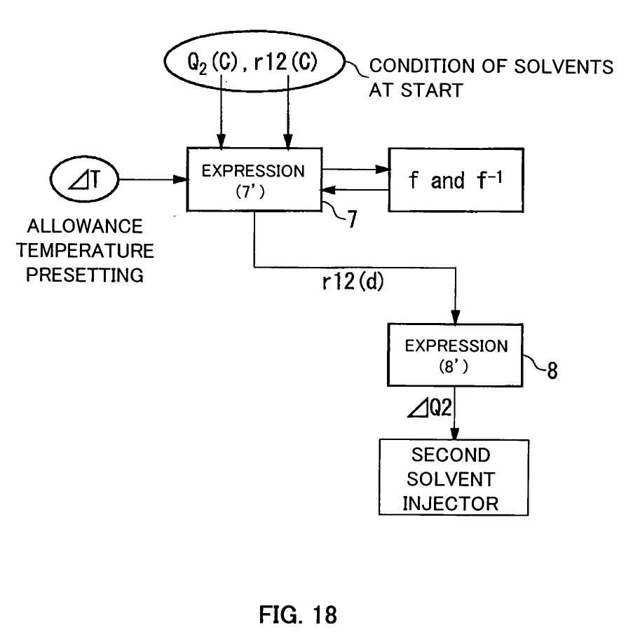

FIG. 19 shows an apparatus of the invention, especially the operation block thereof (from d to C; r constant).

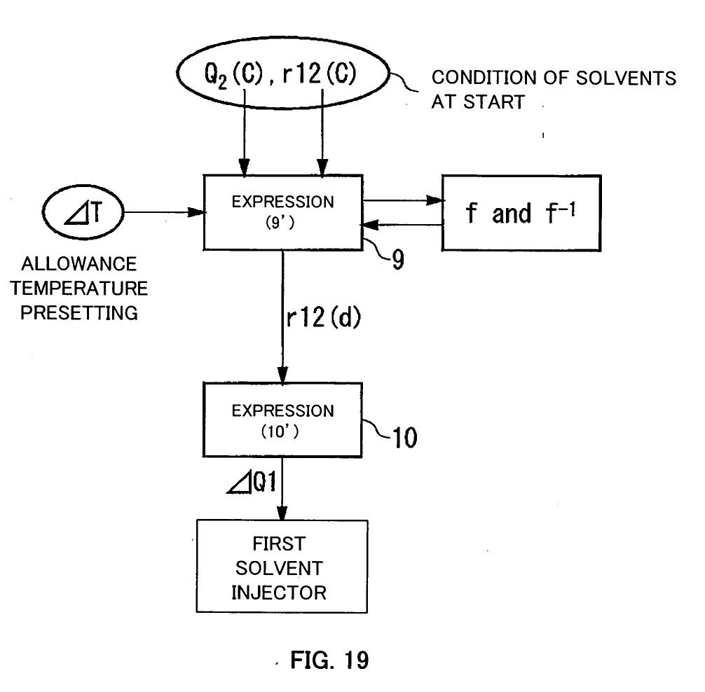

(Description of Reference Numerals and Signs)

1: An operation block with an operation unit for expression (1) or expression (11),
2: An operation block with an operation unit for expression (2) or expression (12),
3: An operation block with an operation unit for expression (3) or expression (13),
4: An operation block with an operation unit for expression (4) or expression (14),
5: An operation block with an operation unit for expression (5) or expression (15),
6: An operation block with an operation unit for expression (6) or expression (16),
7: An operation block with an operation unit for expression (7), expression (7′) or expression (17),
8: An operation block with an operation unit for expression (8), expression (8′) or expression (18),
9: An operation block with an operation unit for expression (9), expression (9′) or expression (19),
10: An operation block with an operation unit for expression (10), expression (10′) or expression (20),
   Point A: A point on a solution/separation temperature (vertical axis) data graph relative to the blend ratio of first and second solvents (parameter) and the composition blend ratio of the second solvent (horizontal axis) of a combination of first and second solvents that is in a separation phase at a temperature T,
   Point B: A point on a solution/separation temperature (vertical axis) data graph relative to the composition blend ratio of the second solvent (horizontal axis) of a combination of first and second solvents that undergoes solution/separation phase change at a temperature lower than the temperature T when having the same blend ratio of first and second solvents (parameter) as that at the point A,
   Point C: A point on a solution/separation temperature (vertical axis) data graph relative to the blend ratio of first and second solvents (parameter) and the composition blend ratio of the second solvent (horizontal axis) of a combination of first and second solvents that is in a separation phase at a temperature T,
   Point d: A point on a solution/separation temperature (vertical axis) data graph relative to the blend ratio of first and second solvents (parameter) in a combination of first and second solvents that undergoes solution/separation phase change at a temperature lower than the temperature T when having the same composition blend ratio of the second solvent (horizontal axis) as that at the point C,
   ABl: The time taken for mixing liquids A and B in a first reactor (liquid A and liquid B have no relation with the above point A and point B),
   ABn: The time taken for mixing liquids A and B in an n-th reactor (liquid A and liquid B have no relation with the above point A and point B),
   BCl: The time taken for mixing liquids A and B and then adding a liquid C thereto for solubilization in a first reactor (liquid A, liquid B and liquid C have no relation with the above point A and point B),
   BCn: The time taken for mixing liquids A and B and then adding a liquid C thereto for solubilization in an n-th reactor (liquid A, liquid B and liquid C have no relation with the above point A and point B),
   ΔT: A preset allowance temperature difference, f(*): A function for deriving a solution/separation temperature from the composition blend ratio of a second solvent (*=rA, etc.),
   f⁻¹(*): An inverse function to the function f (*=solution/separation temperature),
   mix1: The time taken from after the mixing of liquids A and B in a first reactor to before the start of heating the reactor, mix2: The time taken from after the mixing of liquids A and B in a second reactor to before the start of heating the reactor, mix-n: The time taken from after the mixing of liquids A and B in an n-th reactor to before the start of heating the reactor, MIX1: The time taken from after the mixing of liquids A and B in a first reactor to before the finish of heating the reactor, MIXn: The time taken from after the mixing of liquids A and B in an n-th reactor to before the finish of heating the reactor, Move1: The effect and action of a liquid supplier to insert a needle N to a reactor, Move2: The effect and action of a liquid supplier to take out the needle N from the reactor and move it to the position of another reactor,
   R1: A first reactor,
   R2: A second reactor,
   R3: A third reactor,
   Rn: An n-th reactor,
   rA: A composition blend ratio of a second solvent,
   rB: A composition blend ratio of a second solvent,
   rC: A composition blend ratio of a second solvent,
   r12: A blend ratio of first and second solvents,
   T0: A constant temperature lower than TA and higher than TB, or a constant temperature lower than TC and higher than Td; Point V1: A phase start point of a combination of first and second solvents in a separation phase,
   Point V2: A phase start point of a combination of first and second solvents in a solution phase,
   Point W1: A phase point of a combination of first and second solvents that changed to a solution phase through temperature change or through change of the blend ratio of first and second solvents and the composition blend ratio of the second solvent,
   Point W2: A phase point of a combination of first and second solvents that changed to a separation phase through temperature change or through change of the blend ratio of first and second solvents and the composition blend ratio of the second solvent,
   Point X: A phase point of a combination of first and second solvents in a separation phase,
   Point Y: A phase point of a combination of first and second solvents that has changed to a solution phase through temperature elevation at the point X,
   Point Z: A phase point of a combination of first and second solvents that has changed to a solution phase through change of the blend ratio of the first and second solvents and the composition blend ratio of the second solvent at the point X.

### BEST MODE FOR CARRYING OUT THE INVENTION

The entire contents of all the patents and the references explicitly cited in this description shall be incorporated in this description by reference. In addition, the entire contents described in the specification of Japanese Patent Application No.2003-72659, a patent application to be the basis of the priority claimed by the present application, shall be incorporated in this description by reference.

### EXAMPLE 1

To a uniform solution prepared by mixing 5 ml of cyclopentane and 10 ml of DMI at 20° C., added was 5 ml of cyclohexane at the same temperature. This immediately underwent phase separation to form an upper layer principally comprising cycloalkane and a lower layer principally comprising DMI. This method does not require temperature change in the step of substance separation through two-phase separation after the uniform-phase chemical process therein.

To a uniform solution prepared by mixing 10 ml of a bicyclic cycloalkane, decalin, and 5 ml of DMI at 10° C., added was 5 ml of DMF at the same temperature. This immediately underwent phase separation to form an upper layer principally comprising cycloalkane and a lower layer principally comprising DMI and DMF. This method does not require temperature change in the step of substance separation through two-phase separation after the uniform-phase chemical process therein.

Except cyclohexane, also preferred is decalin, a condensation product of two cyclohexane rings, as the first solvent. A solvent set in which the first solvent is decalin and the second solvent is a mixture of DMI and DMF is also preferred. In the claims, the first solvent is a single solvent for evading any confusion. However, like the second solvent, the first solvent may also be a mixture of plural solvents. Concretely, the first solvent may be a mixture of cyclohexane and cyclopentane, or a mixture of cyclohexane and cyclooctane.

The following Examples are to demonstrate the realization of continuous peptide synthesis through two-phase separation from uniform phase with the reactor temperature and the solution temperature kept constant. In the peptide bond formation reaction in these, used is a cyclic amide compound as the second solvent.

### EXAMPLE 2

### (Peptide Synthesis)

In 100 ml of cyclohexane, dissolved was 1 mmol of 3,4,5-tris-octadecyloxy-benzyl 2-amino-3-methyl-butyrate at 25° C. To this, added was 20 ml of an NMP (N-methyl-2-pyrrolidinone) solution containing 3 mmol of Fmoc-Gly-OBt and 5 mmol of diisopropylcarbodiimide (DIPCD), and stirred for 90 minutes. Next, with this reaction system being stirred, a 1:1 (w/w) solution of ethylene carbonate (EC):propylene carbonate (PC) was gradually dropwise added thereto at the same temperature. In this stage, the reaction solution was separated into two phases of an upper layer principally comprising cyclohexane and a lower layer principally comprising NMP, EC and PC. The lower layer solution was removed, and the cyclohexane phase was washed three times with 10 ml of a 1:1 (w/w) solution of ethylene carbonate (EC):propylene carbonate (PC), at 25° C. From the cyclohexane solution, obtained was 3,4,5-tris-octadecyloxy-benzyl 2-[2-(9H-fluorein-9-ylmethoxycarbonylamino)-acetylamino]-3-methyl-butyrate, at an yield of 99%. ¹H-NMR (400 MHz) δ:7.77 (2H, d, J=7.3 Hz), 7.59 (2H, d, J=7.3 Hz), 7.40 (2H, t, J=7.3 Hz), 7.31 (2H, dt, J=0.7, 7.3 Hz), 6.52 (2H, s), 6.38 (1H, d, J=8.4 Hz), 5.44-5.37 (1H, br), 5.10 (1H, d, J=12.1 Hz), 5.02 (1H, d, J=12.1 Hz), 4.62 (2H, dd, J=8.4, 4.8 Hz), 4,42 (2H, d, J=7.0 Hz), 4.24 (1H, t, J=7.0 Hz), 3.96-3.92 (8H, m), 2.21-2.16 (1H, m), 1.81-1.76 (4H, m), 1.75-1.70 (2H, m), 1.48-1.43 (6H, m), 1.37-1.21 (84H, r), 0.91 (3 H, d, J=7.0 Hz), 0.88 (9H, t, J=7.0 Hz), 0.86 (8H, d, J=7.0 Hz); ¹³C-NMR (150 MHz) δ:171.5, 168.7, 156.5, 153.1, 143.6, 141.2, 138.3, 130.0, 127.7, 127.0, 125.0, 120.0, 107.0, 73.4, 69.2, 67.5, 67.4, 57.1, 47.1, 32.0, 31.4, 30.4, 29.8, 29.7, 29.5, 29.4, 26.1, 22.8, 19.0, 17.7, 14.2; MALDI TOF-MS (pos) calcd for C₃₃H₁₃₈N₂_{O}₈ [M+Na]⁺1314, found 1314.

### EXAMPLE 3

### (Peptide Bond Formation Reaction with Amide Compound as Second Solvent)

In 100 ml of methylcyclohexane, dissolved was 1 mmol of 3,4,5-tris-octadecyloxy-benzyl 2-amino-3-methyl-butyrate at 55° C. To this, added was 20 ml of a DMF (dimethylformamide) solution containing 3 mmol of Fmoc-Gly-OBt and 5 mmol of diisopropylcarbodiimide (DIPCD), and stirred for 60 minutes. Next, with this reaction system being stirred, 20 ml of a 1:1 (w/w) solution of ethylene carbonate (EC):propylene carbonate (PC) was gradually dropwise added thereto at the same temperature. In this stage, the reaction solution was separated into two phases of an upper layer principally comprising cyclohexane and a lower layer principally comprising, NMP, EC and PC. The lower layer solution was removed, and the cyclohexane phase was washed three times with 10 ml of a 1:1 (w/w) solution of ethylene carbonate (EC) :propylene carbonate (PC), at 55° C. From the cyclohexane solution, obtained was 3,4,5-tris-octadecyloxy-benzyl 2-[2-(9H-fluorein-9-ylmethoxycarbonylamino)-acetylamino]-3-methyl-butyrate, at an yield of 92%.

### INDUSTRIAL APPLICABILITY

The solvent set of the invention is applicable to any and every process that is interpreted as an exchange of basic substance constitutive elements such as electrons, and it shall be taken in the broad sense of the word. It has a broad meaning of chemical processes for compound production and any other general “chemical reaction”, including internal reaction in organisms and physical reaction with no distinction between them. Specifically, it is applied to intramolecular and intermolecular reaction, intramolecular and intermolecular interaction, electron transfer, separation based on the mobility speed difference between substances, extraction separation and solvent fractionation based on the difference in partition coefficient. A plain example of a chemical process using the solvent set of the invention is liquid-phase peptide synthesis.

1. A method for solubilization in the absence of temperature change in a solvent set of a combination of a first solvent and a second solvent of a mixture of plural solvents, which undergoes temperature-dependent reversible change between solution phase and separation phase, by changing the permittivity or the polarity of the first and second solvents that are in a separation phase, based on the permittivity data of the first and second solvents or the polarity data of the first and second solvents, without changing the temperature thereof;
wherein the permittivity of the first solvent is from 0 to 15 or the polarity (ET30) of the first solvent is less than 20, the permittivity of the second solvent is at least 20 or the polarity (ET30) of the second solvent is at least 25, and the first solvent or at least one elemental solvent of the plural solvents constituting the second solvent is added to the set so that the added amount thereof is to reduce the permittivity difference or the polarity difference between the first solvent and the second solvent that are in a separation phase, relatively by at least 10%, or
a solute capable of dissolving in the first solvent or a solute capable of dissolving in the second solvent is added to the set so that the added amount thereof is to reduce the permittivity difference between the first solvent and the second solvent that are in a separation phase or to reduce the polarity difference between the first solvent and the second solvent that are in a separation phase, relatively by at least 10%.

2. A method for solubilization in the absence of temperature change in a solvent set of a combination of a first solvent and a second solvent of a mixture of plural solvents, which undergoes temperature-dependent reversible change between solution phase and separation phase, by changing the permittivity or the polarity of the first and second solvents that are in a separation phase, based on the permittivity data of the first and second solvents or the polarity data of the first and second solvents, without changing the temperature thereof; wherein the permittivity of the first solvent is from 0 to 15 or the polarity (ET30) of the first solvent is less than 20, the permittivity of the second solvent is at least 20 or the polarity (ET30) of the second solvent is at least 25, and the first solvent or at least one elemental solvent of the plural solvents constituting the second solvent is added to the set so that the added amount thereof is to increase the permittivity difference or the polarity difference between the first solvent and the second solvent that are in a solution phase, relatively by at least 10%, or
a solute capable of dissolving in the first solvent or a solute capable of dissolving in the second solvent is added to the set so that the added amount thereof is to increase the permittivity difference between the first solvent and the second solvent that are in a solution phase or to increase the polarity difference between the first solvent and the second solvent that are in a solution phase, relatively by at least 10%.

3. A method for solubilization in the absence of temperature change in a solvent set of a combination of a first solvent and a second solvent of a mixture of plural solvents, which undergoes temperature-dependent reversible change between solution phase and separation phase and which is in a separation phase, based on the data of the solution/separation critical temperature relative to the blend ratio of the first solvent and the second solvent and the composition blend ratio of the second solvent; the method comprising comparing the blend ratio of the first and second solvents and the composition blend ratio of the second solvent for phase solution/separation at a critical temperature, TA, with the blend ratio of the first and second solvents and the composition blend ratio of the second solvent for phase solution/separation at a critical temperature, TB that is lower than TA, and adding the first solvent and/or a solvent of constituting the second solvent to the set in order that the blend ratio of the first and second solvents and the composition blend ratio of the second solvent for phase solution/separation at TA may be the blend ratio of the first and second solvents and the composition blend ratio of the second solvent for phase solution/separation at TB lower than TA, to thereby make the first and second solvents, which are in a separation phase at a constant temperature lower than TA and higher than TB and which undergo phase solution/separation at TA, solubilize at a constant temperature lower than TA and higher than TB.

4. A method for phase separation in the absence of temperature change in a solvent set of a combination of a first solvent and a second solvent of a mixture of plural solvents, which undergoes temperature-dependent reversible change between solution phase and separation phase and which is in a solution phase, based on the data of the solution/separation critical temperature relative to the blend ratio of the first solvent and the second solvent and the composition blend ratio of the second solvent; the method comprising comparing the blend ratio of the first and second solvents and the composition blend ratio of the second solvent for phase solution/separation at a critical temperature, TA, with the blend ratio of the first and second solvents and the composition blend ratio of the second solvent for phase solution/separation at a critical temperature, TB that is lower than TA, and adding the first solvent and/or a solvent of constituting the second solvent to the set in order that the blend ratio of the first and second solvents and the composition blend ratio of the second solvent for phase solution/separation at TB may be the blend ratio of the first and second solvents and the composition blend ratio of the second solvent for phase solution/separation at TA higher than TB, to thereby make the first and second solvents, which are in a solution phase at a constant temperature lower than TA and higher than TB and which undergo phase solution/separation at TB, separated at a constant temperature lower than TA and higher than TB.

5. The method as claimed in claim 3, wherein the blend ratio, r12(A), of the first and second solvents for solution/separation at TA and the blend ratio, r12(B) of the first and second solvents for solution/separation at TB are set equal to each other (r12(A)=r12(B)), and in the solvent set of a combination of the first and second solvents having the same blend ratio, the composition blend ratio, rB, of the second solvent of the first and second solvents for solution/separation at TB is obtained from the data of the maximum temperature change range T-range of the solution/separation critical temperature obtained by changing the second solvent composition blend ratio to the uppermost limit, the allowance temperature delta-T of temperature difference between the present TA and TB, and the composition blend ratio, rA, of the second solvent of the first and second solvents for solution/separation at TA, according to the following expression (1):
$$rB = \frac{ T}{Trange} + rA \qquad ( 1 )$$

6. The method as claimed in claim 5, wherein the addition amount of the first solvent, delta-Q1 is obtained according to the following expression (2) and the addition amount of the second solvent, delta-Q2 is according to the following expression (3), from the values of the amount of the second solvent Q2(A), r12, rA and rB:
$$\begin{matrix}Δ {Q}_{2} = \frac{rB - rA}{1 - rB} \cdot {Q}_{2} ( A ) & ( 2 ) \\ Δ {Q}_{1} = r 12 \cdot \frac{rB - rA}{1 - rB} \cdot Q ( A ) & ( 3 )\end{matrix}$$

7. The method as claimed in claim 4, wherein the blend ratio, r12(A), of the first and second solvents for solution/separation at TA and the blend ratio, r12(B) of the first and second solvents for solution/separation at TB are set equal to each other (r12(A)=r12(B)), and from the maximum temperature change range, T-range of the solution/separation critical temperature obtained from the solution/separation critical temperature data of the solvent set of a combination of the first and the second solvents having the same blend ratio, the temperature difference between the preset TA and TB, allowance temperature delta-T, and the composition blend ratio, rB of the second solvent of the first and second solvents for solution/separation at TB, obtained is the composition blend ratio rA of the second solvent of the first and second solvents for solution/separation at TA is obtained according to the following expression (4):
$$rA = rB - \frac{Δ T}{Trange} \qquad ( 4 )$$

8. The method as claimed in claim 7, wherein the addition amount of the first solvent, delta-Q1 is obtained according to the following expression (5) and the addition amount of the second solvent, delta-Q2 is according to the following expression (6), from the values of the amount of the second solvent Q2(B), r12, rA and rB:
$$Δ {Q}_{2} = \frac{rB - rA}{rA} \cdot {Q}_{2} ( B ) \qquad ( 5 )$$
$$Δ {Q}_{1} = r 12 \cdot \frac{rB \cdot rA}{rA} \cdot {Q}_{2} ( B ) \qquad ( 6 )$$

9. The method as claimed in claim 3, wherein the composition blend ratio, r, of the second solvent of the first and second solvents for solution/separation at TA is set equal to the composition blend ration, r, of the second solvent of the first and second solvents for solution/separation at TB (rA=rB), and from the solution/separation critical temperature data of the solvent set of the combination of the second solvent having the same composition blend ratio and the first solvent, obtained are a function f(r12) to give the solution/separation critical temperature with a variable of the blend ratio r12 of the first and second solvents, and an inverse function f⁻¹(T) to f(r12) to give the blend ratio r12 of the first and second solvents with a variable of the solution/separation critical temperature T, and from the temperature difference between the preset TA and TB, allowance temperature delta-T, and the blend ratio r12(A) of the first and second solvents for solution/separation at TA, obtained is the blend ratio r12(B) of the first and second solvents for solution/separation at TB according to the following expression (7):
r12(B)=f⁻¹[f(r12(A))− [symbol] T] (7)

10. The method as claimed in claim 9, wherein the addition amount of the second solvent, delta-Q2 is obtained according to the following expression (8):
$$Δ {Q}_{2} = \frac{r 12 ( A ) - r 12 ( B )}{r 12 ( b )} \cdot {Q}_{2} ( A ) \\ Δ {Q}_{1} = 0 \qquad ( 8 )$$

11. The method as claimed in claim 4, wherein the composition blend ratio, rA, of the second solvent of the first and second solvents for solution/separation at TA is set equal to the composition blend ration, rB, of the second solvent of the first and second solvents for solution/separation at TB (rA=rB), and from the solution/separation critical temperature data of the solvent set of the combination of the second solvent having the same composition blend ratio and the first solvent, obtained are a function f(r12) to give the solution/separation critical temperature with a variable of the blend ratio r12 of the first and second solvents, and an inverse function f⁻¹(T) to f(r12) to give the blend ratio r12 of the first and second solvents with a variable of the solution/separation critical temperature T, and from the temperature difference between the preset TA and TB, allowance temperature delta-T, and the blend ratio r12(B) of the first and second solvents for solution/separation at TB, obtained is the blend ratio r12(A) of the first and second solvents for solution/separation at TA according to the following expression (9):
r12(A)=f⁻¹[f(r12(B))− [symbol] T] (9)

12. The method as claimed in claim 11, wherein the addition amount of the first solvent, delta-Q1 is obtained according to the following expression (10):
$$Δ {Q}_{1} = [ r 12 ( A ) - r 12 ( B ) ] \cdot {Q}_{2} ( B ) \\ Δ {Q}_{2} = 0 \qquad ( 10 )$$

13. A method for phase separation in the absence of temperature change in a solvent set of a combination of a first solvent and a second solvent of a single solvent or a mixture of plural solvents, which undergoes temperature-dependent reversible change between solution phase and separation phase, by carrying out at least once a solubilization process for the first solvent and the second solvent of a single solvent or a mixture of plural solvent and then adding a substance except the first and second solvents to the solubilized solution as a result of the solubilization process for phase separation of the solution with no temperature change, wherein the additive substance is such that, in a combination of a mixture resulting from addition of the additive substance to the second solvent of a single solvent or a mixture of plural solvents and the first solvent, its addition to the second solvent in an amount of 10% by volume of the second solvent changes the solution/separation critical temperature of the solvent set by at least 10 degrees, thereby attaining the phase change into separation phase at a constant temperature.

14. The method for phase separation at a constant temperature as claimed in claim 13, wherein the additive substance is an alkyl carbonate.

15. An apparatus for solubilization of a solvent set of a combination of a first solvent and a second solvent of a mixture of plural solvents, which undergoes temperature-dependent reversible change between solution phase and separation phase and which is in a separation phase, wherein the composition blend ratio of the second solvent of the solvent set of the first and second solvents, of which the solution/separation critical temperature is represented by TA, the blend ratio of the first and second solvents is by r12, the second solvent amount is by Q2(A) and the blend ratio of any two constitutive components of the second solvent is by rA, is changed to a composition blend ratio, rB of the second solvent of the combination of the first and second solvents, of which the solution/separation critical temperature is TB that is lower than TA by the allowance temperature delta-T for the preset solution/separation critical temperature thereof and the blend ratio of the first and second solvents is the same as above and is r12, by adding the first and second solvents to the solvent set on the basis of the solution/separation critical temperature data relative to the blend ratio of the first solvent and the second solvent and to the composition blend ratio of the second solvent, to thereby solubilize the separation-phase solvent set of a combination of the first and second solvents; the apparatus comprising an initial data-inputting unit for inputting the data rA and Q2(A), a presetting and inputting unit for the allowance temperature delta-T, a database reference unit of taking thereinto the data of the maximum temperature change range, T-range of the solution/separation critical temperature obtained through maximum limit change of the composition blend ratio of the second solvent in the solvent set of a combination of the first and second solvents of which the blend ratio of the first and second solvents is r12, from a solution/separation critical temperature database, an operation unit for obtaining rB from the values of delta-T, T-range and rA according to the following expression (11), an operation unit for obtaining the addition amount delta-Q1 of the first solvent from the values of rB obtained in the above operation unit, and rA and Q2(A) according to the following expression (12), and an operation unit for obtaining the addition amount delta-Q2 of the second solvent according to the following expression (13):
$$\begin{matrix}rB = \frac{Δ T}{Trange} + rA & ( 11 ) \\ Δ {Q}_{2} = \frac{rB - rA}{1 - rB} \cdot {Q}_{2} ( A ) & ( 12 ) \\ Δ {Q}_{1} = r 12 \cdot \frac{rB - rA}{1 - rB} \cdot {Q}_{2} ( A ) & ( 13 )\end{matrix}$$

16. An apparatus for phase separation of a solvent set of a combination of a first solvent and a second solvent of a mixture of plural solvents, which undergoes temperature-dependent reversible change between solution phase and separation phase and which is in a solution phase, wherein the composition blend ratio of the second solvent of the solvent set of the first and second solvents, of which the solution/separation critical temperature is represented by TB, the blend ratio of the first and second solvents is by r12, the second solvent amount is by Q2(B) and the blend ratio of any two constitutive components of the second solvent is by rB, is changed to a composition blend ratio, rA of the second solvent of the combination of the first and second solvents, of which the solution/separation critical temperature is TA that is higher than TB by the allowance temperature delta-T for the preset solution/separation critical temperature thereof and the blend ratio of the first and second solvents is the same as above and is r12, by adding the first and second solvents to the solvent set on the basis of the solution/separation critical temperature data relative to the blend ratio of the first solvent and the second solvent and to the composition blend ratio of the second solvent, to thereby change the solution-phase solvent set of a combination of the first and second solvents into a separation-phase one; the apparatus comprising an initial data-inputting unit for inputting the data rB and Q2(B), a presetting and inputting unit for the allowance temperature delta-T, a database reference unit of taking thereinto the data of the maximum temperature change range, T-range of the solution/separation critical temperature obtained through maximum limit change of the composition blend ratio of the second solvent in the solvent set of a combination of the first and second solvents of which the blend ratio of the first and second solvents is r12, from a solution/separation critical temperature database, an operation unit for obtaining rA from the values of delta-T, T-range and rB according to the following expression (14), an operation unit for obtaining the addition amount delta-Q1 of the first solvent from the values of rA obtained in the above operation unit, and rB and Q2(B) according to the following expression (16), and an operation unit for obtaining the addition amount delta-Q2 of the second solvent according to the following expression (15):
$$\begin{matrix}rA = rB - \frac{Δ T}{Trange} & ( 14 ) \\ Δ {Q}_{2} = \frac{rB - rA}{rA} \cdot {Q}_{2} ( B ) & ( 15 ) \\ Δ {Q}_{1} = r 12 \cdot \frac{rB - rA}{rA} \cdot {Q}_{2} ( B ) & ( 16 )\end{matrix}$$

17. An apparatus for solubilization of a solvent set of a combination of a first solvent and a second solvent of a mixture of plural solvents, which undergoes temperature-dependent reversible change between solution phase and separation phase and which is in a separation phase, wherein the composition blend ratio of the second solvent of the solvent set of the first and second solvents, of which the solution/separation critical temperature is represented by TA, the blend ratio of the first and second solvents is by r12(A), the second solvent amount is by Q2(A) and the blend ratio of any two constitutive components of the second solvent is by r, is so changed that the composition blend ratio of any two constitutive components of the second solvent may be the same as above, r (rA=rB) at TB that is lower than TA by the allowance temperature delta-T for the preset solution/separation critical temperature thereof an the blend ratio of the first and second solvents may be r12(B), by adding the second solvent to the solvent set on the basis of the solution/separation critical temperature data relative to the blend ratio of the first solvent and the second solvent and to the composition blend ratio of the second solvent, to thereby solubilize the separation-phase solvent set of a combination of the first and second solvents; the apparatus comprising an initial data-inputting unit for inputting the data r12(A) and Q2(A), a presetting and inputting unit for the allowance temperature delta-T, a database reference unit for referring to a function database having a function f(r12) for obtaining the solution/separation critical temperature of the solvent set with a variable of the blend ratio r12 of the first and second solvents, from the solution/separation critical temperature data of the solvent set of a combination of the first and second solvents in which the blend ratio of any two constitutive components of the second solvent is r, and having an inverse function f⁻¹(T) to f(r12) for obtaining the blend ratio r12 of the first and second solvents with a variable of the solution/separation critical temperature T, and comprising an operation unit for obtaining r12(B) from the values of r12(A) and delta-T according to the following expression (17), and an operation unit for obtaining the addition amount delta-Q2 of the second solvent from the values of r12(B) obtained in the above operation unit, and r12(A) and Q2(A) according to the following expression (18):
$$\begin{matrix}r 12 ( B ) = {f}^{- 1} [ f ( r 12 ( A ) ) - Δ T ] & ( 17 ) \\ Δ {Q}_{2} = \frac{r 12 ( A ) - r 12 ( B )}{r 12 ( B )} \cdot {Q}_{2} ( A ) \\ Δ {Q}_{1} = 0 & ( 18 )\end{matrix}$$

18. An apparatus for phase separation of a solvent set of a combination of a first solvent and a second solvent of a mixture of plural solvents, which undergoes temperature-dependent reversible change between solution phase and separation phase and which is in a solution phase, wherein the composition blend ratio of the second solvent of the solvent set of the first and second solvents, of which the solution/separation critical temperature is represented by TB, the blend ratio of the first and second solvents is by r12(B), the second solvent amount is by Q2(B) and the blend ratio of any two constitutive components of the second solvent is by r, is so changed that the composition blend ratio of any two constitutive components of the second solvent may be the same as above, r (rB=rA) at TA that is higher than TB by the allowance temperature delta-T for the preset solution/separation critical temperature thereof an the blend ratio of the first and second solvents may be r12(A), by adding the second solvent to the solvent set on the basis of the solution/separation critical temperature data relative to the blend ratio of the first solvent and the second solvent and to the composition blend ratio of the second solvent, to thereby change the solution-phase solvent set of a combination of the first and second solvents into a separation-phase one; the apparatus comprising an initial data-inputting unit for inputting the data r12(B) and Q2(B), a presetting and inputting unit for the allowance temperature delta-T, a database reference unit for referring to a function database having a function f(r12) for obtaining the solution/separation critical temperature of the solvent set with a variable of the blend ratio r12 of the first and second solvents, from the solution/separation critical temperature data of the solvent set of a combination of the first and second solvents in which the blend ratio of any two constitutive components of the second solvent is r, and having an inverse function f⁻¹(T) to f(r12) for obtaining the blend ratio r12 of the first and second solvents with a variable of the solution/separation critical temperature T, and comprising an operation unit for obtaining r12(A) from the values of r12(B) and delta-T according to the following expression (19), and an operation unit for obtaining the addition amount delta-Q2 of the second solvent from the values of r12(A) obtained in the above operation unit, and r12(B) and Q2(B) according to the following expression (20):
r12(A)=f⁻¹[f(r12(B))− [symbol] T] (19) [symbol]
Q₁=[r12(A)−r12(B)]·Q₂(B) [symbol]
Q₂=0 (20)
